(19) United States
(12) Patent Application Publication
(10) Pub. No.: US 2026/0342966 A1
(43) Pub. Date: Oct. 29, 2026

(54) METHOD, APPARATUS, AND MEDIUM FOR VIDEO PROCESSING

(71) Applicant: Bytedance Inc., Los Angeles, CA (US)

(72) Inventors: Kai ZHANG, Los Angeles, CA (US); Li ZHANG, Los Angeles, CA (US)

(21) Appl. No.: 19/715,955

(22) Filed: Jun. 22, 2026

Related U.S. Application Data
(63) Continuation of application No. PCT/US2024/061291, filed on Dec. 20, 2024.
(60) Provisional application No. 63/614,247, filed on Dec. 22, 2023.

(51) Int. Cl. H04N 19/105; H04N 19/88

(52) U.S. Cl. CPC H04N 19/105; H04N 19/88

(57) ABSTRACT

Embodiments of the disclosure provide a solution for video processing. A method for video processing is proposed. The method includes: determining, for a conversion between a video unit of a video and a bitstream of the video, a first candidate list used in a geometric partitioning mode (GPM) for the video unit; obtaining a second candidate list based on the first candidate list, where a reordering process is applied to at least one of the first candidate list or the second candidate list, or the reordering process is not applied to the first and second candidate lists; and performing the conversion based on the second candidate list.

### CROSS-REFERENCE TO RELATED APPLICATIONS

This application is a continuation of International Application No. PCT/US2024/061291, filed on Dec. 20, 2024, which claims the benefit of U.S. provisional application No. 63/614,247, filed on Dec. 22, 2023. The entire contents of these applications are hereby incorporated by reference in their entireties.

### FIELDS

Embodiments of the present disclosure relates generally to video processing techniques, and more particularly, to methods for geometry prediction mode.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; and performing the conversion based on the second candidate list. In this way, it can improve coding performance and efficiency.

In a second aspect, another method for video processing is proposed. The method comprises: determining, for a conversion between a video unit of a video and a bitstream of the video, whether a geometric partitioning mode (GPM) partition of the video unit is coded with affine motion compensation; determining the number of applicable GPM split modes based on the determining; and performing the conversion based on one or more GPM split modes. In this way, it can improve coding performance and efficiency.

In a third aspect, another method for video processing is proposed. The method comprises: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; and performing the conversion based on the prediction. In this way, it can improve coding performance and efficiency.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; and generating the bitstream based on the second candidate list.

In a seventh aspect, another non-transitory computer-readable recording medium is proposed. The non-transitory computer-readable recording medium stores a bitstream of a video which is generated by a method performed by an apparatus for video processing. The method comprises: determining, for a conversion between a video unit of a video and a bitstream of the video, whether a geometric partitioning mode (GPM) partition of the video unit is coded with affine motion compensation; determining the number of applicable GPM split modes based on the determining; and generating the bitstream based on one or more GPM split modes.

In an eighth aspect, another non-transitory computer-readable recording medium is proposed. The non-transitory computer-readable recording medium stores a bitstream of a video which is generated by a method performed by an apparatus for video processing. The method comprises: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; and generating the bitstream based on the prediction.

In a ninth aspect, a method for storing a bitstream of a video is proposed. The method comprises: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; generating the bitstream based on the second candidate list; and storing the bitstream in a non-transitory computer-readable recording medium.

In a tenth aspect, a method for storing a bitstream of a video is proposed. The method comprises: determining, for a conversion between a video unit of a video and a bitstream of the video, whether a geometric partitioning mode (GPM) partition of the video unit is coded with affine motion compensation; determining the number of applicable GPM split modes based on the determining; generating the bitstream based on one or more GPM split modes; and storing the bitstream in a non-transitory computer-readable recording medium.

In an eleventh aspect, a method for storing a bitstream of a video is proposed. The method comprises: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; generating the bitstream based on the prediction; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates positions of spatial and temporal neighboring blocks used in AMVP/merge candidate list construction;

FIG. 5 illustrates positions of non-adjacent candidate in ECM;

FIG. 6A and FIG. 6B illustrate control point based affine motion model;

FIG. 7 illustrates an example affine MVF per subblock;

FIG. 8 illustrates locations of inherited affine motion predictors;

FIG. 9 illustrates control point motion vector inheritance;

FIG. 10 illustrates locations of Candidates position for constructed affine merge mode;

FIG. 11A and FIG. 11B illustrate spatial neighbors for deriving affine merge candidates;

FIG. 12 illustrates from non-adjacent neighbors to constructed affine merge candidates;

FIG. 13 illustrates an example of generating an HAPC;

FIG. 14 illustrates an illustration of regression based affine merge candidate derivation;

FIG. 15 illustrates template matching performs on a search area around initial MV;

FIG. 16 illustrates template and the corresponding reference template;

FIG. 17 illustrates template and reference template for block with sub-block motion using the motion information of the subblocks of current block;

FIG. 18 illustrates deriving sub-CU motion field obtained by applying a motion shift based on the neighboring motion information;

FIG. 19 illustrates examples of the GPM splits grouped by identical angles;

FIG. 20 illustrates uni-prediction MV selection for geometric partitioning mode;

FIG. 21 illustrates exemplified generation of a bending weight w_0 using geometric partitioning mode;

FIG. 22 illustrates the ramp function for the weights for GPM blending based on the displacement (d) from a predicted sample position to the GPM partitioning boundary and the blending area size (i);

FIG. 23A-FIG. 23C illustrate available IPM candidates, respectively;

FIG. 23D illustrates GPM with inter and intra prediction;

FIG. 24 illustrates the edge on templates;

FIG. 25A illustrates GPM with translational motion compensation (TMC) only and FIG. 25B illustrates GPM with TMC and affine motion compensation (AMC);

FIG. 26 illustrates a flowchart of a method for video processing in accordance with embodiments of the present disclosure;

FIG. 27 illustrates a flowchart of a method for video processing in accordance with embodiments of the present disclosure;

FIG. 28 illustrates a flowchart of a method for video processing in accordance with embodiments of the present disclosure; and

FIG. 29 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

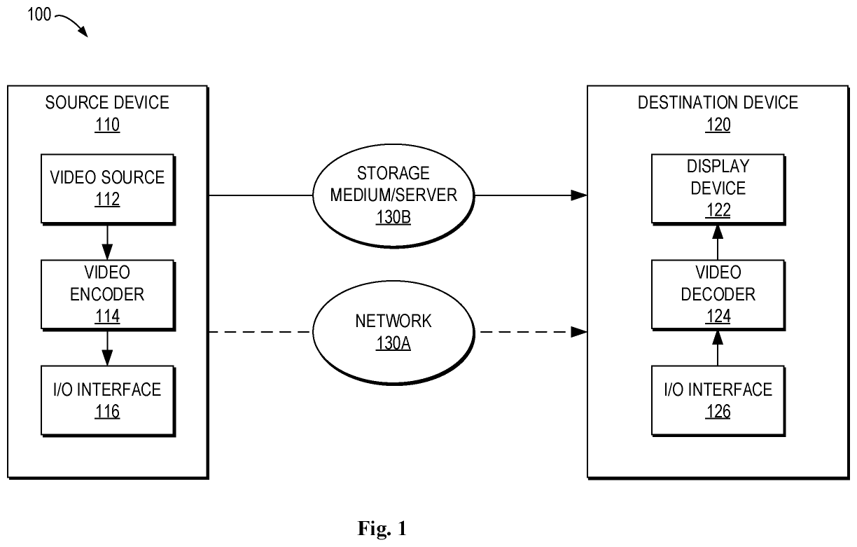

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

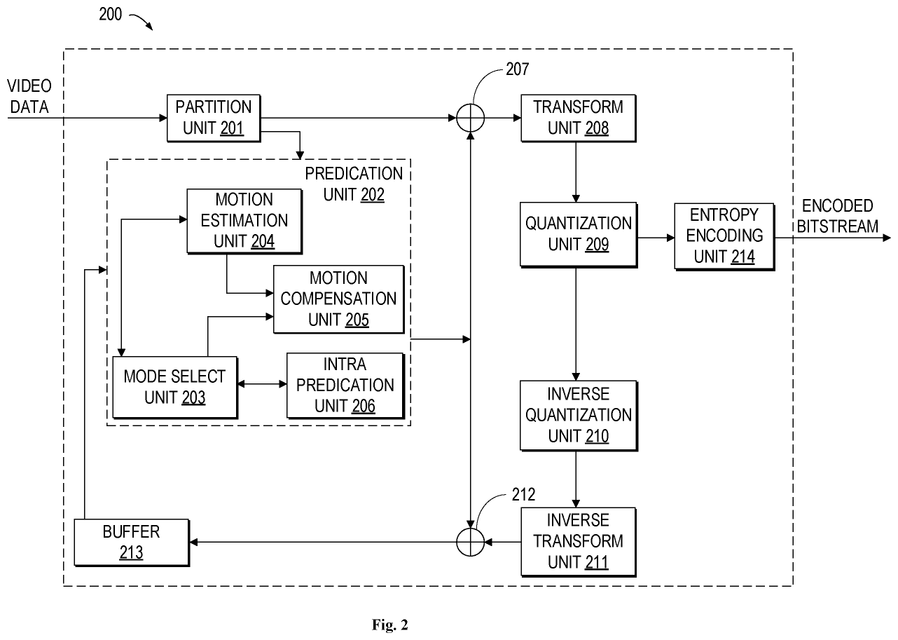

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

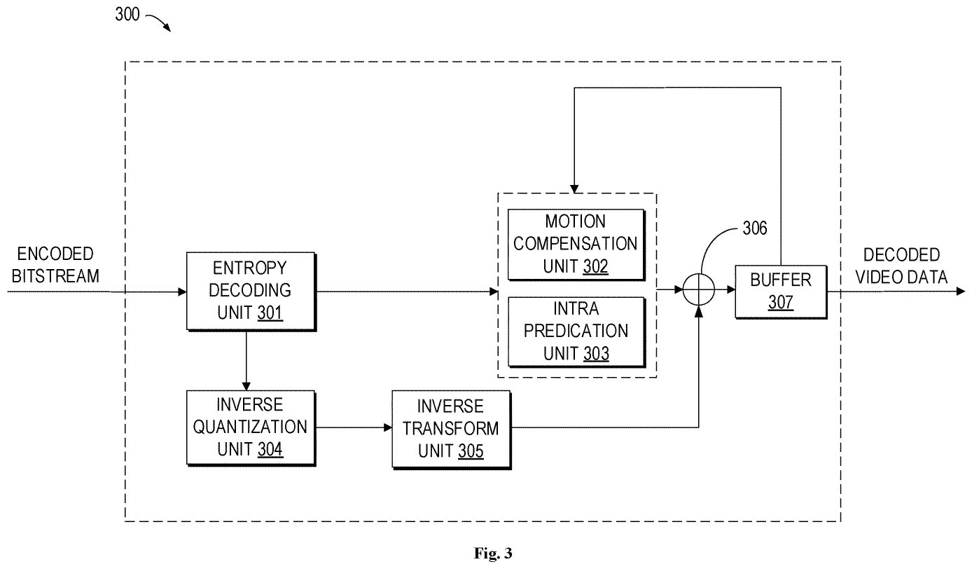

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. Brief Summary

The present disclosure is related to video coding technologies. Specifically, it is about Affine motion prediction method in video coding. The ideas may be applied individually or in various combination, to any video coding standard or non-standard video codec.

### 2. Introduction

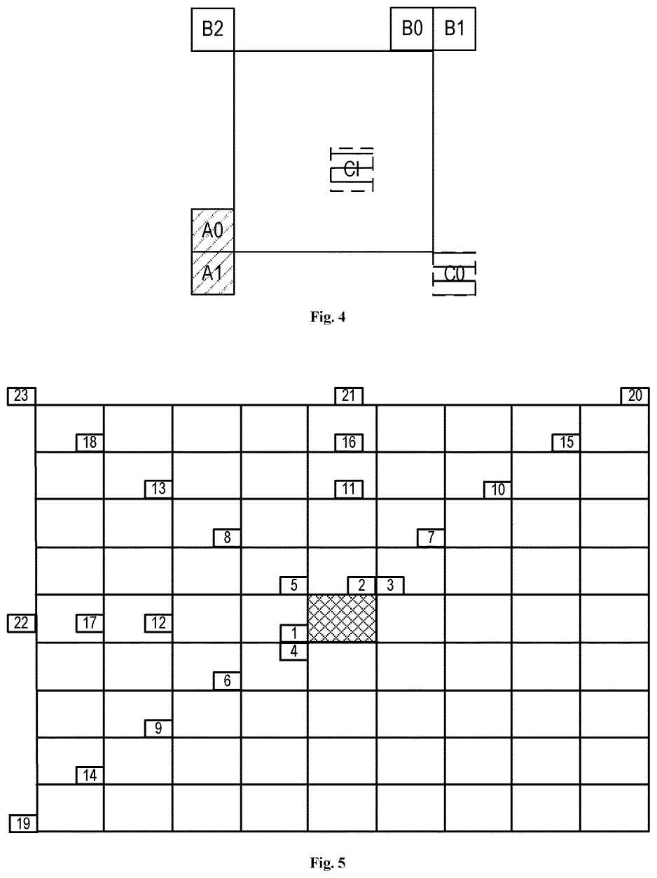

The exponential increasing of multimedia data poses a critical challenge for video coding. To satisfy the increasing demands for more efficient compression technology, ITU-T and ISO/IEC have developed a series of video coding standards in the past decades. In particular, the ITU-T produced H.261 and H.263, ISO/IEC produced MPEG-1 and MPEG-4 visual, and the two organizations jointly developed the H.262/MPEG-2 Video, H.264/MPEG-4 Advanced Video Coding (AVC), H.265/HEVC and the latest VVC standards. Since H.262/MPEG-2, hybrid video coding framework is employed wherein in intra/inter prediction plus transform coding are utilized. FIG. 4 shows positions of spatial and temporal neighboring blocks used in AMVP/merge candidate list construction.

### 2.1 MVP in Video Coding

Inter prediction aims to remove the temporal redundancy between adjacent frames, which serves as an indispensable component in the hybrid video coding framework. Specifically, inter prediction makes use of the contents specified by motion vector (MV) as the predicted version of the current to-be-coded block, thus only residual signals and motion information are transmitted in the bitstream. To reduce the cost for MV signaling, motion vector prediction (MVP) came into being as an effective mechanism to convey motion information. Early strategies simply use the MV of a specified neighboring block or the median MV of neighboring blocks as MVP. In H.265/HEVC competing mechanism was involved where the optimal MVP is selected from multiple candidates through rate distortion optimization (RDO). In particular, advanced MVP (AMVP) mode and merge mode are devised with different motion information signaling strategy. With the AMVP mode, a reference index, a MVP candidate index referring to an AMVP candidate list and motion vector difference (MVD) is signaled. Regarding the merge mode, only a merge index referring to a merge candidate list is signaled, and all the motion information associated with the merge candidate is inherited. Both AMVP mode and merge mode need to construct MVP candidate list, and the details of the construction process for these two modes are described as follows.

AMVP mode: AMVP exploits spatial-temporal correlation of motion vector with neighboring blocks, which is used for explicit transmission of motion parameters. For each reference picture list, a motion vector candidate list is constructed by firstly checking availability of left, above temporally neighboring positions, removing redundant candidates and adding zero vector to make the candidate list to be constant length. For spatial motion vector candidate derivation, two motion vector candidates are eventually derived based on motion vectors of blocks located in five different positions as depicted in FIG. 4. The five neighboring blocks located at B0, B1, B2, and A0, A1 are classified into two groups, where Group A includes the three above spatial neighboring blocks and Group B includes the two left spatial neighboring blocks. The two MV candidates are respectively derived with the first available candidate from Group A and Group B in a predefined order. For temporal motion vector candidate derivation, one motion vector candidate is derived based on two different collocated positions (bottom-right (C0) and central (C1)) checked in order, as depicted in FIG. 4. To avoid redundant MV candidates, duplicated motion vector candidates in the list are abandoned. If the number of potential candidates is smaller than two, additional zero motion vector candidates are added to the list. FIG. 5 shows positions of non-adjacent candidate in ECM.

Merge mode: Similar to AMVP mode, MVP candidate list for merge mode comprises of spatial and temporal candidates as well. For spatial motion vector candidate derivation, at most four candidates are selected with order A1, B1, B0, A0 and B2 after performing availability and redundant checking. For temporal merge candidate (TMVP) derivation, at most one candidate is selected from two temporal neighboring blocks (C0 and C1). When there are not enough merge candidates with spatial and temporal candidates, combined bi-predictive merge candidates and zero MV candidates are added to MVP candidate list. Once the number of available merge candidates reaches the signaled maximally allowed number, the merge candidate list construction process is terminated.

In VVC, the construction process for merge mode is further improved by introducing the history-based MVP (HMVP), which incorporates the motion information of previously coded blocks which may be far away from current block. In VVC, HMVP merge candidates are appended to merge list after the spatial MVP and TMVP. In this method, the motion information of a previously coded block is stored in a table and used as MVP for the current CU. The table with multiple HMVP candidates is maintained with first-in-first-out strategy during the encoding/decoding process. Whenever there is a non-subblock inter-coded CU, the associated motion information is added to the last entry of the table as a new HMVP candidate.

During the standardization of VVC, Non-adjacent MVP was proposed to facilitate better motion information derivation by exploiting the non-adjacent area. In ECM software, Non-adjacent MVP are inserted between TMVP and HMVP, where the distances between non-adjacent spatial candidates and current coding block are based on the width and height of current coding block as depicted in FIG. 5.

### 2.2 Affine Motion Compensated Prediction

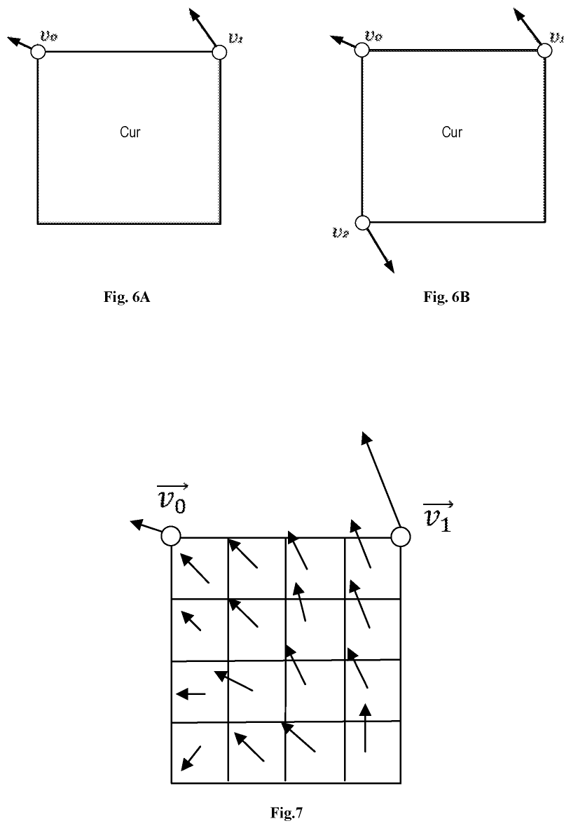

In HEVC, only translation motion model is applied for motion compensation prediction (MCP). While in the real world, there are many kinds of motion, e.g. zoom in/out, rotation, perspective motions and the other irregular motions. In VVC, a block-based affine transform motion compensation prediction is applied. FIG. 6A and FIG. 6B shows control point based affine motion model. As shown FIG. 6A and FIG. 6B, the affine motion field of the block is described by motion information of two control point (4-parameter) or three control point motion vectors (6-parameter).

For 4-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = \frac{{mv}_{1 y} - {mv}_{0 y}}{W} x + \frac{{mv}_{1 y} - {mv}_{0 x}}{W} y + {mv}_{0 y}\end{matrix} ; \qquad ( 1 )$$

For 6-parameter affine motion model, motion vector at sample location (x, y) in a block is derived as:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} , \qquad ( 2 )$$

where (mv0x, mv0y) is motion vector of the top-left corner control point, (mv1x, mv1y) is motion vector of the top-right corner control point, and (mv2x, mv2y) is motion vector of the bottom-left corner control point.

In order to simplify the motion compensation prediction, block based affine transform prediction is applied. To derive motion vector of each 4×4 luma subblock, the motion vector of the center sample of each subblock, as shown in FIG. 7, is calculated according to above equations, and rounded to 1/16 fraction accuracy. Then the motion compensation interpolation filters are applied to generate the prediction of each subblock with derived motion vector. The subblock size of chroma-components is also set to be 4×4. The MV of a 4×4 chroma subblock is calculated as the average of the MVs of the top-left and bottom-right luma subblocks in the collocated 8×8 luma region.

As done for translational motion inter prediction, there are also two affine motion inter prediction modes: affine merge mode and affine AMVP mode.

### 2.2.1 Affine Merge Prediction

Affine merge mode can be applied for CUs with both width and height larger than or equal to 8. In this mode the CPMVs of the current CU is generated based on the motion information of the spatial neighboring CUs. There can be up to five CPMVP candidates and an index is signalled to indicate the one to be used for the current CU. In VVC, the following three types of CPVM candidate are used to form the affine merge candidate list:
Inherited affine merge candidates that extrapolated from the CPMVs of the neighbour CUs;
Constructed affine merge candidates CPMVPs that are derived using the translational MVs of the neighbour CUs;
Zero MVs.

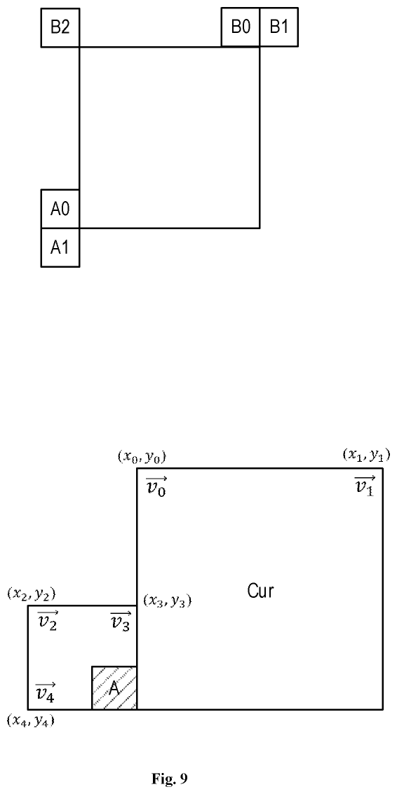

In VVC, there are maximum two inherited affine candidates, which are derived from affine motion model of the neighboring blocks, one from left neighboring CUs and one from above neighboring CUs. The candidate blocks are shown in FIG. 8. For the left predictor, the scan order is A0->A1, and for the above predictor, the scan order is B0->B1->B2. Only the first inherited candidate from each side is selected. No pruning check is performed between two inherited candidates. When a neighboring affine CU is identified, its control point motion vectors are used to derived the CPMVP candidate in the affine merge list of the current CU. As shown in FIG. 9, if the neighbour left bottom block A is coded in affine mode, the motion vectors v₂, v₃ and v₄ of the top left corner, above right corner and left bottom corner of the CU which contains the block A are attained. When block A is coded with 4-parameter affine model, the two CPMVs of the current CU are calculated according to v₂, and v₃. In case that block A is coded with 6-parameter affine model, the three CPMVs of the current CU are calculated according to v₂, v₃ and v₄.

FIG. 8 shows locations of inherited affine motion predictors. FIG. 9 shows control point motion vector inheritance.

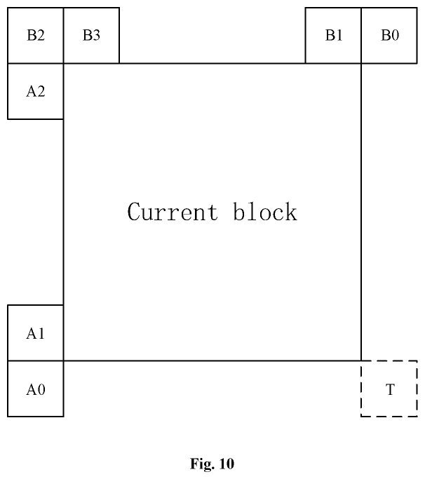

Constructed affine candidate means the candidate is constructed by combining the neighbor translational motion information of each control point. The motion information for the control points is derived from the specified spatial neighbors and temporal neighbor shown in FIG. 10. CPMVk (k=1, 2, 3, 4) represents the k-th control point. For CPMV1, the B2->B3->A2 blocks are checked and the MV of the first available block is used. For CPMV2, the B1->B0 blocks are checked and for CPMV3, the A1->A0 blocks are checked. For TMVP is used as CPMV4 if it's available.

After MVs of four control points are attained, affine merge candidates are constructed based on those motion information. The following combinations of control point MVs are used to construct in order:

### {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}.

The combination of 3 CPMVs constructs a 6-parameter affine merge candidate and the combination of 2 CPMVs constructs a 4-parameter affine merge candidate. To avoid motion scaling process, if the reference indices of control points are different, the related combination of control point MVs is discarded. FIG. 10 shows locations of Candidates position for constructed affine merge mode.

After inherited affine merge candidates and constructed affine merge candidate are checked, if the list is still not full, zero MVs are inserted to the end of the list.

### 2.2.2 Affine AMVP Prediction

Affine AMVP mode can be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AVMP candidate list size is 2 and it is generated by using the following four types of CPVM candidate in order:
Inherited affine AMVP candidates that extrapolated from the CPMVs of the neighbour CUs,
Constructed affine AMVP candidates CPMVPs that are derived using the translational MVs of the neighbour CUs,
Translational MVs from neighboring CUs,
Zero MVs.

The checking order of inherited affine AMVP candidates is same to the checking order of inherited affine merge candidates. The only difference is that, for AVMP candidate, only the affine CU that has the same reference picture as in current block is considered. No pruning process is applied when inserting an inherited affine motion predictor into the candidate list.

Constructed AMVP candidate is derived from the specified spatial neighbors shown in FIG. 10. The same checking order is used as done in affine merge candidate construction. In addition, reference picture index of the neighboring block is also checked. The first block in the checking order that is inter coded and has the same reference picture as in current CUs is used. There is only one When the current CU is coded with 4-parameter affine mode, and mv0 and mv1 are both available, they are added as one candidate in the affine AMVP list. When the current CU is coded with 6-parameter affine mode, and all three CPMVs are available, they are added as one candidate in the affine AMVP list. Otherwise, constructed AMVP candidate is set as unavailable.

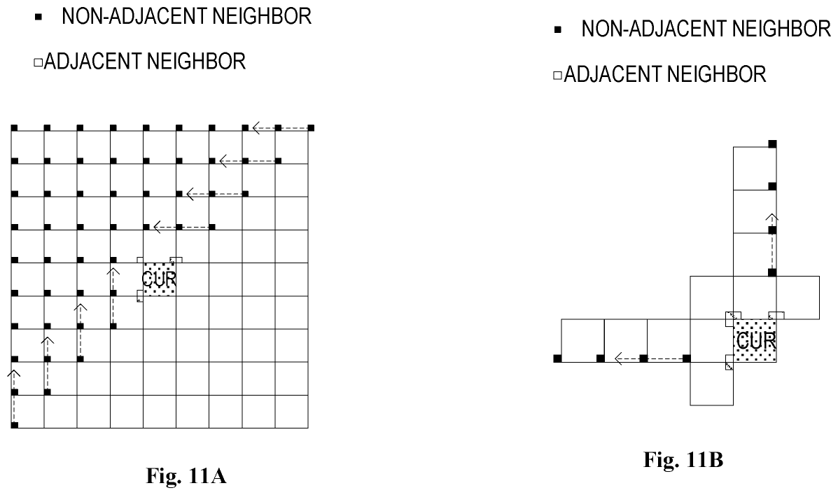

FIG. 11A and FIG. 11B show spatial neighbors for deriving affine merge candidates: FIG. 11A is for deriving inherited affine merge candidates and FIG. 11B is for deriving constructed affine merge candidates.

If affine AMVP list candidates is still less than 2 after valid inherited affine AMVP candidates and constructed AMVP candidate are inserted, mv0, mv1 and mv2 will be added, in order, as the translational MVs to predict all control point MVs of the current CU, when available. Finally, zero MVs are used to fill the affine AMVP list if it is still not full.

### 2.2.3 New Affine Candidates Derivation Methods

In ECM-6.0, 3 additional Affine merge and AMVP candidate derivation methods are integrated, which are Non-adjacent spatial candidates, History-parameter-based candidates and Regression based affine candidates.

### 2.2.3.1 Non-Adjacent Spatial Candidates

In ECM-6.0, non-adjacent spatial neighbors are investigated to provided candidates for both Affine merge and Affine AMVP. The pattern of obtaining non-adjacent spatial candidates is shown in FIG. 11A and FIG. 11B. Same as the non-adjacent regular merge candidates, the distances between non-adjacent spatial candidates and current coding block are also defined based on the width and height of current CU.

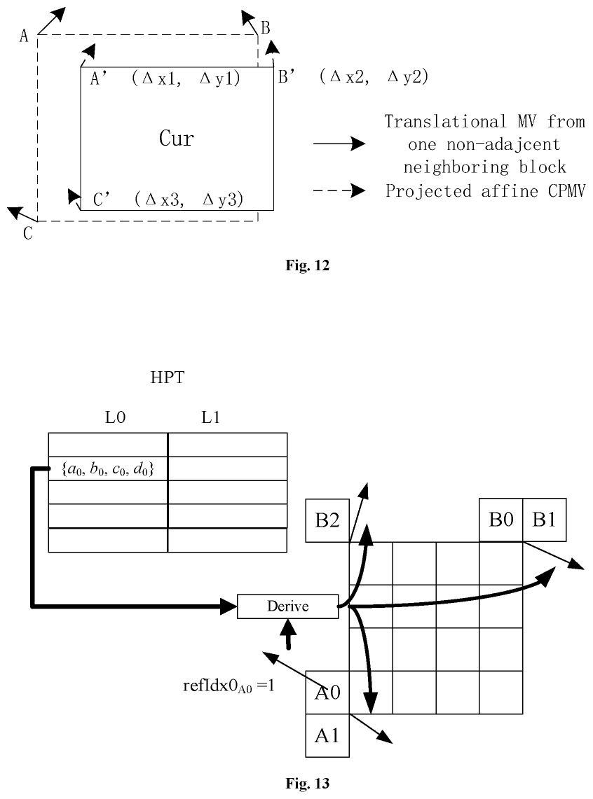

The motion information of the non-adjacent spatial neighbors in FIG. 11A and FIG. 11B is utilized to generate additional inherited and constructed affine merge candidates. Specifically, to generate inherited candidates, the non-adjacent spatial neighbors are checked based on their distances to the current block, i.e., from near to far. At a specific distance, only the first available neighbor which is coded with Affine mode from each side (e.g., the left and above) of the current block is included. As indicated in FIG. 11A, the checking of the neighbors on the left and above sides are performed from bottom-to-up and right-to-left, respectively. For constructed candidates, as shown in the FIG. 11B, the positions of one left and above non-adjacent spatial neighbors are firstly determined independently; After that, the location of the top-left neighbor can be determined accordingly to form a rectangular virtual block together with the left and above non-adjacent neighbors. FIG. 12 shows from non-adjacent neighbors to constructed affine merge candidates. The motion information of the three non-adjacent neighbors is used to form the CPMVs at the top-left (A), top-right (B) and bottom-left (C) of the virtual block, which is projected to the current CU to generate the corresponding constructed candidates, as shown in FIG. 12.

### 2.2.3.2 History-Parameter-Based Affine Candidates

History-parameter-based affine model inheritance (HAMI) allows the affine model to be inherited from a previously affine-coded block which may not be neighboring to the current block. A history-parameter table (HPT) is established. An entry of HPT stores a set of affine parameters: a, b, c and d, each of which is represented by a 16-bit signed integer. Entries in HPT is categorized by reference list and reference index. Five reference indices are supported for each reference list in HPT. In a formular way, the category of HPT (denoted as HPTCat) is calculated as:

HPTCat(RefList,RefIdx)=5×RefList+min(RefIdx,4) (3)

where RefList and RefIdx represents a reference picture list (0 or 1) and a reference index, respectively. For each category, at most seven entries can be stored, resulting in 70 entries totally in HPT. At the beginning of each CTU row, the number of entries for each category is initialized as zero. After decoding an affine-coded CU with reference list RefListcur and RefIdxcur, the affine parameters are utilized to update entries in the category HPTCat(RefListcur, RefIdxcur) in a way similar to HMVP table updating.

A history-affine-parameter-based candidate (HAPC) is derived from a neighbouring 4×4 block denoted as A0, A1, B0, B1 or B2 in FIG. 10 and a set of affine parameters stored in a corresponding entry in HPT. The MV of a neighbouring 4×4 block served as the base MV. In a formulating way, the MV of the current block at position (x, y) is calculated as:

$$\{ \begin{matrix}m {v}^{h} ( x , y ) = a ( x - {x}_{b a s e} ) + c ( y - {y}_{b a s e} ) + m {v}_{base}^{h} \\ m {v}^{v} ( x , y ) = b ( x - {x}_{b a s e} ) + d ( y - {y}_{b a s e} ) + {mv}_{base}^{v}\end{matrix} , \qquad ( 4 )$$

where (mvhbase, mvvbase) represents the MV of the neighbouring 4×4 block, (xbase, ybase) represents the center position of the neighbouring 4×4 block. (x, y) can be the top-left, top-right and bottom-left corner of the current block to obtain the corner-position MVs (CPMVs) for the current block, or it can be the center of the current block to obtain a regular MV for the current block.

FIG. 13 shows an example of how to derive an HAPC from block AG. The affine parameters {a0, b0, c0, d0} are directly fetched from one entry of category HPTIdx(RefListA0, refIdx0A0) in HPT. The affine parameters from HPT, with the center position of AG as the base position, and the MV of block AG as the base MV, are used together to derive the CPMVs for an affine merge HAPC, or an affine AMVP HAPC. They can also be used to derive MVs located at the center of the current block, as regular merge candidates. A HAPC can be put into the sub-block-based merge candidate list, the affine AMVP candidate list or the regular merge candidate list. As a response to new HAPCs being introduced, the size of sub-block-based merge candidate list is increased from five to ten and twelve for random access and low-delay B configurations, respectively. Besides, the size of regular merge candidate list is increased from ten to eleven for random access configurations to accommodate the newly added regular merge candidates.

### 2.2.3.3 Regression Based Affine Candidate

In ECM-6.0, the regression based affine merge candidates are derived and added to the affine merge list. Subblock motion field from a previously coded affine CU and motion information from adjacent subblocks of a current CU are used as the input to the regression process to derive proposed affine candidates.

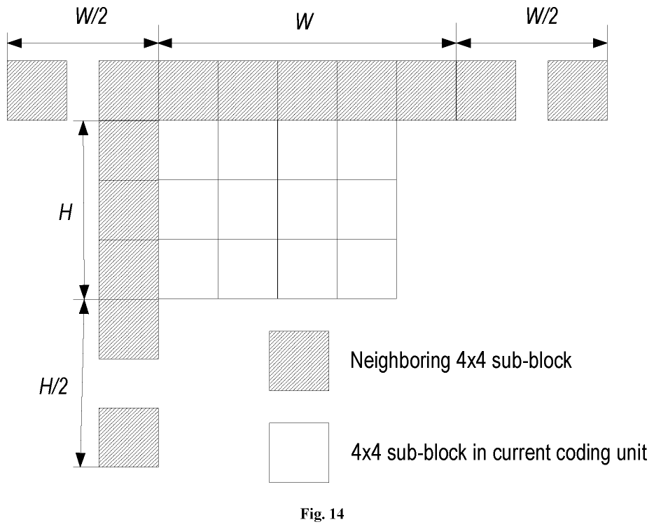

The previously coded affine CU can be identified from scanning through non-adjacent positions and the affine HMVP table. Adjacent subblock information of current CU is fetched from 4×4 sub-blocks represented by the grey zone as depicted in FIG. 14. For each sub-block, given a reference list, the corresponding motion vector and center coordinate of the sub-block may be used.

For each affine CU, up to 2 affine candidates can be derived. One with adjacent subblock information and one without. All the linear-regression-generated candidates are pruned and collected into one candidate sub-group, TM cost based ARMC process is applied when ARMC is enabled. Afterwards, up to N linear-regression-generated candidates are added to the affine merge list when N affine CUs are found. FIG. 14 is an illustration of regression based affine merge candidate derivation.

### 2.3 Template Matching Merge/AMVP Mode in ECM

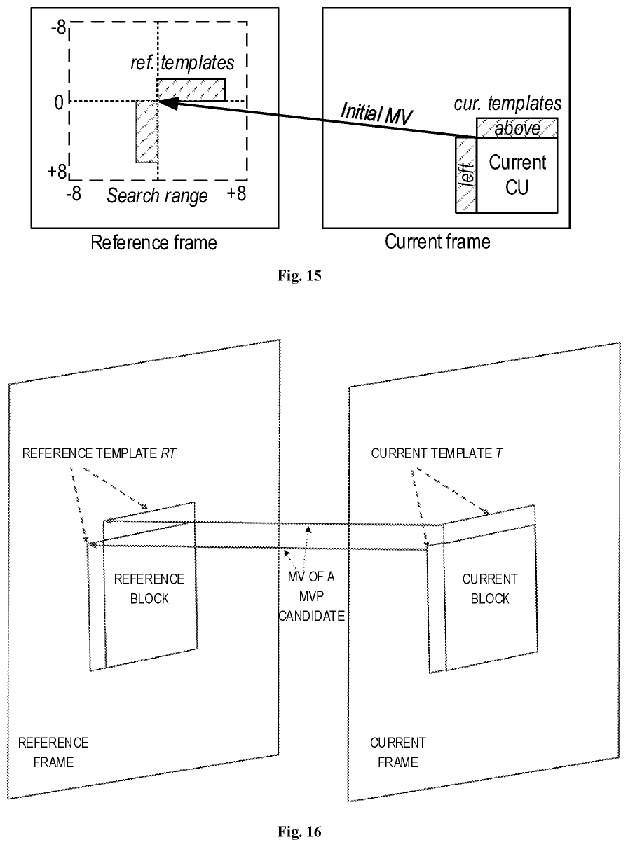

Template matching (TM) merge/AMVP mode is a decoder-side MV derivation method to refine the motion information of the current CU by finding the closest match between a template (i.e., top and/or left neighboring blocks of the current CU) in the current picture and a block (i.e., same size to the template) in a reference picture. As illustrated in FIG. 15, a better MV is to be searched around the initial motion of the current CU within a [−8, +8]-pel search range. FIG. 15 shows template matching performs on a search area around initial MV.

In AMVP mode, an MVP candidate is determined based on the template matching error to pick up the one which reaches the minimum difference between the current block and the reference block templates, and then TM performs only for this particular MVP candidate for MV refinement. TM refines this MVP candidate, starting from full-pel MVD precision (or 4-pel for 4-pel AMVR mode) within a [−8, +8]-pel search range by using iterative diamond search. The AMVP candidate may be further refined by using cross search with full-pel MVD precision (or 4-pel for 4-pel AMVR mode), followed sequentially by half-pel and quarter-pel ones depending on AMVR mode. This search process ensures that the MVP candidate still keeps the same MV precision as indicated by adaptive motion vector resolution (AMVR) mode after TM process.

In the merge mode, similar search method is applied to the merge candidate indicated by the merge index. TM merge may perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching may work as an independent process or an extra MV refinement process between block-based and subblock-based bilateral matching (BM) methods, depending on whether BM can be enabled or not according to its enabling condition check. When BM and TM are both enabled for a CU, the search process of TM stops at half-pel MVD precision and the resulted MVs are further refined by using the same model-based MVD derivation method as in DMVR.

### 2.4 Adaptive Reorder of Merge Candidates (ARMC)

Inspired by the spatial correlation between reconstructed neighboring pixels and the current coding block, adaptive reorder of merge candidates (ARMC) was proposed to refine the candidates order in a given candidate list. The underlying assumption is that the candidates with less template matching cost have higher probability to be chosen through RDO process, hence should be placed in front positions within the list to reduce the signaling cost.

The reordering method is applied to regular merge mode, template matching (TM) merge mode, and affine merge mode (excluding the SbTMVP candidate). For the TM merge mode, merge candidates are reordered before the refinement process.

After a merge candidate list is constructed, merge candidates are divided into several subgroups. The subgroup size is set to 5. Merge candidates in each subgroup are reordered ascendingly according to cost values based on template matching. For simplification, merge candidates in the last but not the first subgroup are not reordered.

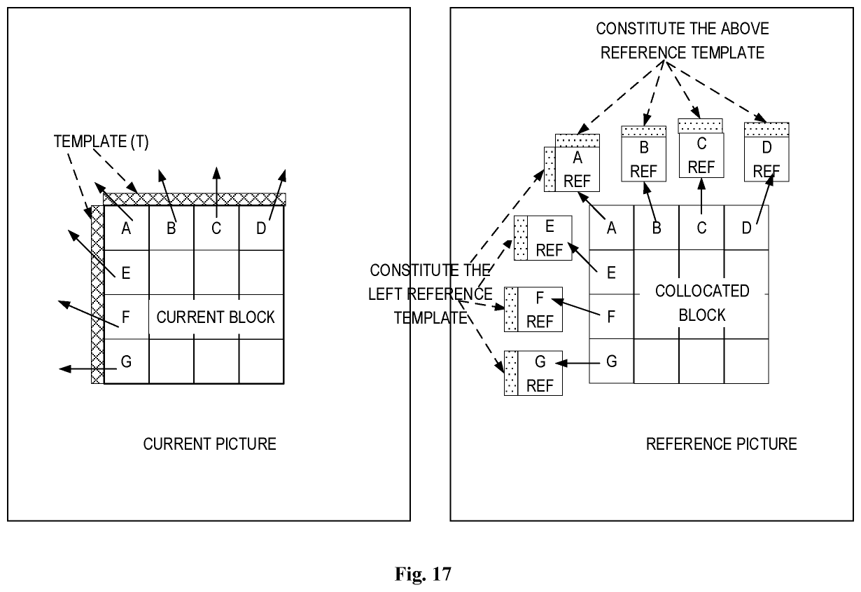

The template matching cost is measured by the sum of absolute differences (SAD) between samples of a template of the current block and their corresponding reference template. The template comprises a set of reconstructed samples neighboring to the current block, while reference template is located by the same motion information of the current block, as illustrated in FIG. 16. When a merge candidate utilizes bi-directional prediction, the reference samples of the template of the merge candidate are also generated by bi-prediction.

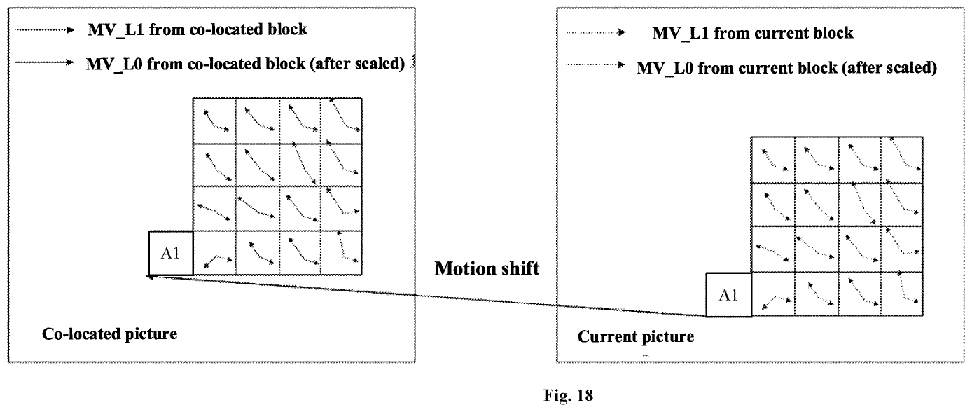

For subblock-based merge candidates with subblock size equal to Wsub*Hsub, the above template comprises several sub-templates with the size of Wsub×K, and the left template comprises several sub-templates with the size of K×Hsub. As shown in FIG. 17, the motion information of the subblocks in the first row and the first column of current block is used to derive the reference samples of each sub-template.

### 2.5 Subblock-Based Temporal Motion Vector Prediction (SbTMVP)

VVC supports the subblock-based temporal motion vector prediction (SbTMVP) method. Similar to the TMVP, SbTMVP takes advantage of the motion field in the collocated picture to facilitate more precise MVP derivation. The same collocated picture used by TMVP is used for SbTVMP. SbTMVP differs from TMVP mainly in two aspects. Firstly, SbTMVP enables sub-CU level motion prediction whereas TMVP predicts motion at CU level; Secondly, compared with TMVP that fetches the temporal MV from the collocated block in the collocated picture (the collocated block is the bottom-right or center block relative to the current CU), SbTMVP applies a motion shift before fetching the temporal motion information from the collocated picture, where the motion shift is obtained by re-using the MV from one of the spatial neighboring blocks of the current CU. FIG. 16 shows template and the corresponding reference template.

FIG. 18 illustrates the derivation process of the sub-block level motion field for SbTMVP. In particular, the motion information of left-bottom sub-block A1 is firstly fetched, if either of the MVs in reference list0 and list1 points to the collocated frame, then the corresponding MV will be identified as motion shift. Otherwise, zero my will be used as motion shift.

Once the motion shift is determined, the specified regions in the collocated frame is employed to derive sub-block level motion field. Assuming A1′ motion is used as motion shift as depicted in FIG. 15. Then for each sub-CU, the motion information of its corresponding block (the smallest motion grid that covers the center sample) in the collocated picture is fetched to provide motion information, where MV scale operation is firstly performed to align the reference frames of the temporal motion vectors to those of the current CU. FIG. 17 shows template and reference template for block with sub-block motion using the motion information of the subblocks of current block. FIG. 18 shows deriving sub-CU motion field obtained by applying a motion shift based on the neighboring motion information.

In VVC and ECM, in addition to CU level MVP candidate list, a sub-CU level MVP candidate list is also constructed to provide more precise motion prediction for the current CU, which comprises the motion fields produced by both SbTMVP and AFFINE methods. In particular, only one SbTMVP candidate is included and is always placed in the first entry of the constructed sub-CU level MVP candidate list, whereas multiple AFFINE candidates are included in the list after performing template matching-based reordering, where those with smaller costs are placed in fronter positions.

### 2.6 Geometric Partitioning Mode (GPM)

In VVC, a geometric partitioning mode is supported for inter prediction. The geometric partitioning mode is signalled using a CU-level flag as one kind of merge mode, with other merge modes including the regular merge mode, the MMVD mode, the CIIP mode and the subblock merge mode. In total 64 partitions are supported by geometric partitioning mode for each possible CU size w×h=2^{m}×2ⁿ with m, n∈{3 . . . 6} excluding 8×64 and 64×8.

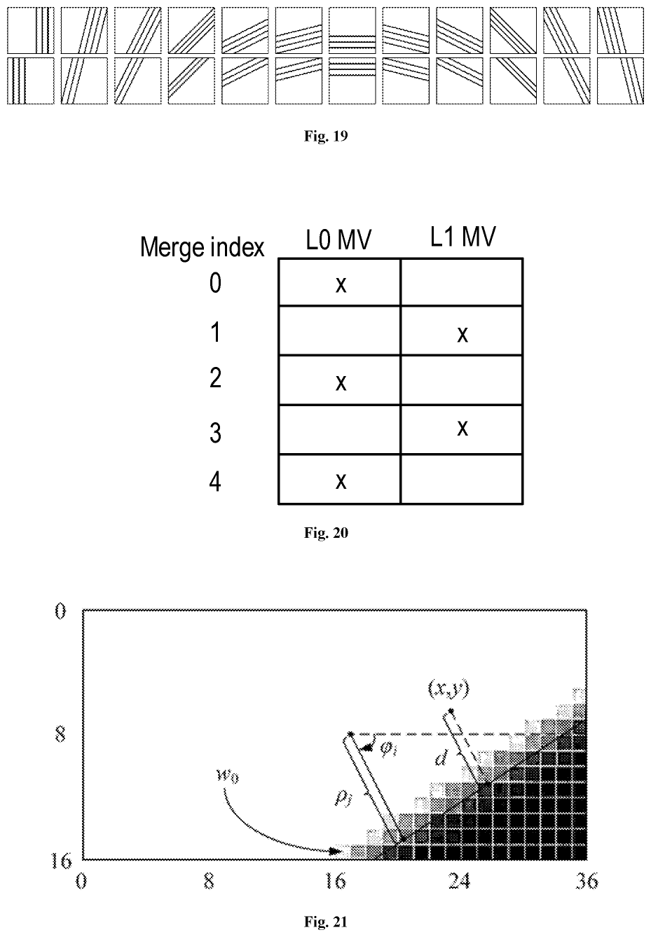

When this mode is used, a CU is split into two geometry partitions by a geometrically located straight line (FIG. 19). The location of the splitting line is mathematically derived from the angle and offset parameters of a specific partition. Each part of a geometric partition in the CU is inter-predicted using its own motion; only uni-prediction is allowed for each partition, that is, each part has one motion vector and one reference index. The uni-prediction motion constraint is applied to ensure that same as the conventional bi-prediction, only two motion compensated prediction are needed for each CU.

If geometric partitioning mode is used for the current CU, then a geometric partition index indicating the partition mode of the geometric partition (angle and offset), and two merge indices (one for each partition) are further signalled. The number of maximum GPM candidate size is signalled explicitly in SPS and specifies syntax binarization for GPM merge indices. After predicting each of part of the geometric partition, the sample values along the geometric partition edge are adjusted using a blending processing with adaptive weights. This is the prediction signal for the whole CU, and transform and quantization process will be applied to the whole CU as in other prediction modes. Finally, the motion field of a CU predicted using the geometric partition modes is stored.

### 2.6.1 Uni-Prediction Candidate List Construction

The uni-prediction candidate list is derived directly from the merge candidate list constructed according to the extended merge prediction process. Denote n as the index of the uni-prediction motion in the geometric uni-prediction candidate list. The LX motion vector of the n-th extended merge candidate, with X equal to the parity of n, is used as the n-th uni-prediction motion vector for geometric partitioning mode. These motion vectors are marked with “x” in FIG. 20. In case a corresponding LX motion vector of the n-th extended merge candidate does not exist, the L(1−X) motion vector of the same candidate is used instead as the uni-prediction motion vector for geometric partitioning mode.

### 2.6.2 Blending Along the Geometric Partitioning Edge

After predicting each part of a geometric partition using its own motion, blending is applied to the two prediction signals to derive samples around geometric partition edge. The blending weight for each position of the CU are derived based on the distance between individual position and the partition edge.

The distance for a position (x, y) to the partition edge are derived as:

d(x,y)=(2x+1−w)cos(φᵢ)+(2y+1−h)sin(φᵢ)−ρⱼ (2-1)

ρⱼ=ρ_{x,j} cos(φᵢ)+ρ_{y,j} sin(φⱼ) (2-2)

$${ρ}_{x , j} = \{ \begin{matrix}0 & i \% 16 = 8 or ( i \% 16 \neq 0 and h \geq w ) \\ \pm ( j \times w ) >> 2 & otherwise\end{matrix} \qquad ( 2 ‐ 3 )$$

$${ρ}_{y , j} = \{ \begin{matrix}\pm ( j \times h ) >> 2 & i \% 16 = 8 or ( i \% 16 \neq 0 and h \geq w ) \\ 0 & otherwise\end{matrix} \qquad ( 2 ‐ 4 )$$

where i,j are the indices for angle and offset of a geometric partition, which depend on the signaled geometric partition index. The sign of ρ_{x,j} and ρ_{y,j} depend on angle index i.

The weights for each part of a geometric partition are derived as following:

wIdxL(x,y)=partIdx?32+d(x,y):32−d(x,y) (2-5)

$${w}_{0} ( x , y ) = \frac{Clip 3 ( 0 , 8 , ( wIdxL ( xy ) + 4 ) >> 3 )}{8} \qquad ( 2 ‐ 6 )$$

w₁(x,y)=1−w₀(x,y) (2-7).

The partIdx depends on the angle index i. One example of weigh w₀ is illustrated in FIG. 21 which shows exemplified generation of a bending weight w₀ using geometric partitioning mode.

2.6.3 Geometric Partitioning Mode (GPM) with Merge Motion Vector Differences (MMVD)

GPM in VVC is extended by applying motion vector refinement on top of the existing GPM uni-directional MVs. A flag is first signalled for a GPM CU, to specify whether this mode is used. If the mode is used, each geometric partition of a GPM CU can further decide whether to signal MVD or not. If MVD is signalled for a geometric partition, after a GPM merge candidate is selected, the motion of the partition is further refined by the signalled MVDs information. All other procedures are kept the same as in GPM.

The MVD is signaled as a pair of distance and direction, similar as in MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) involved in GPM with MMVD (GPM-MMVD). In addition, when pic_fpel_mmvd_enabled_flag is equal to 1, the MVD is left shifted by 2 as in MMVD.

2.6.4 Geometric Partitioning Mode (GPM) with Adaptive Blending

In VVC, the final prediction samples are generated with by blending the prediction of the two prediction signals using weighted average. Two integer blending matrices (W₀ and W₁) are used. The weights in the GPM blending matrices are derived from the ramp function based on the displacement from a predicted sample position to the GPM partitioning boundary. The blending area size is fixed to two (2 samples on each side of the GPM partition split boundary).

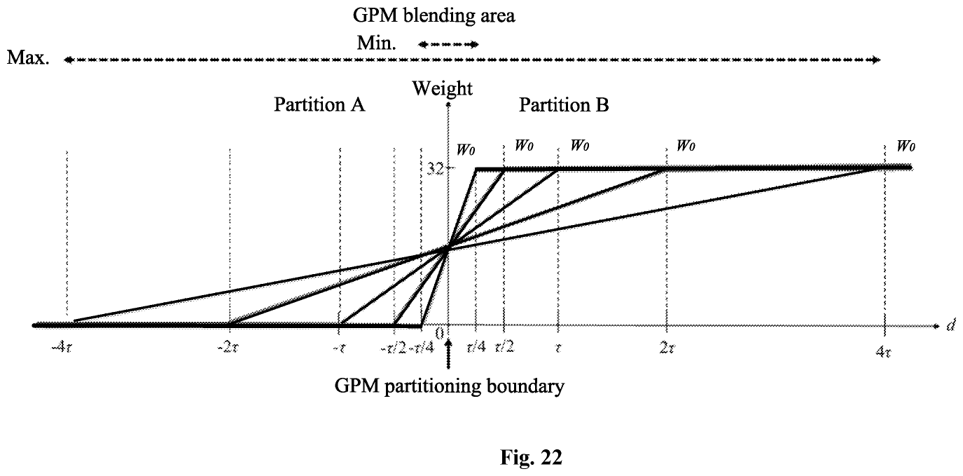

The blending process in ECM is improved by adding four extra blending area sizes (quarter, half, double, and quadrupole of the existing area size) as shown in FIG. 22. A CU level flag is coded to signal the selected blending area size is signalled. Furthermore, the extended weighting precision is utilized, in which the maximum value of the weighs is changed from 8 (in VVC) to 32 to accommodate the extended blending area sizes. FIG. 22 shows the ramp function for the weights for GPM blending based on the displacement (d) from a predicted sample position to the GPM partitioning boundary and the blending area size (τ).

2.6.5 Geometric Partitioning Mode (GPM) with Template Matching (TM)

Template matching is applied to GPM. When GPM mode is enabled for a CU, a CU-level flag is signaled to indicate whether TM is applied to both geometric partitions. Motion information for each geometric partition is refined using TM. When TM is chosen, a template is constructed using left, above or left and above neighboring samples according to partition angle, as shown in Table 1. The motion is then refined by minimizing the difference between the current template and the template in the reference picture using the same search pattern of merge mode with half-pel interpolation filter disabled.

TABLE 1
Template for the 1st and 2nd geometric partitions, where A represents using above samples,
L represents using left samples, and L + A represents using both left and above samples.

| Partition angle | 0 | 2 | 3 | 4 | 5 | 8 | 11 | 12 | 13 | 14 |
|---|---|---|---|---|---|---|---|---|---|---|
| 1^{st} partition | A | A | A | A | L + A | L + A | L + A | L + A | A | A |
| 2^{nd} partition | L + A | L + A | L + A | L | L | L | L | L + A | L + A | L + A |
| Partition angle | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

A GPM candidate list is constructed as follows:
Interleaved List-0 MV candidates and List-1 MV candidates are derived directly from the regular merge candidate list, where List-0 MV candidates are higher priority than List-1 MV candidates. A pruning method with an adaptive threshold based on the current CU size is applied to remove redundant MV candidates.
Interleaved List-1 MV candidates and List-0 MV candidates are further derived directly from the regular merge candidate list, where List-1 MV candidates are higher priority than List-0 MV candidates. The same pruning method with the adaptive threshold is also applied to remove redundant MV candidates.
Zero MV candidates are padded until the GPM candidate list is full.

The GPM-MMVD and GPM-TM are exclusively enabled to one GPM CU. This is done by firstly signaling the GPM-MMVD syntax. When both two GPM-MMVD control flags are equal to false (i.e., the GPM-MMVD are disabled for two GPM partitions), the GPM-TM flag is signaled to indicate whether the template matching is applied to the two GPM partitions. Otherwise (at least one GPM-MMVD flag is equal to true), the value of the GPM-TM flag is inferred to be false.

2.6.6 GPM with Inter and Intra Prediction

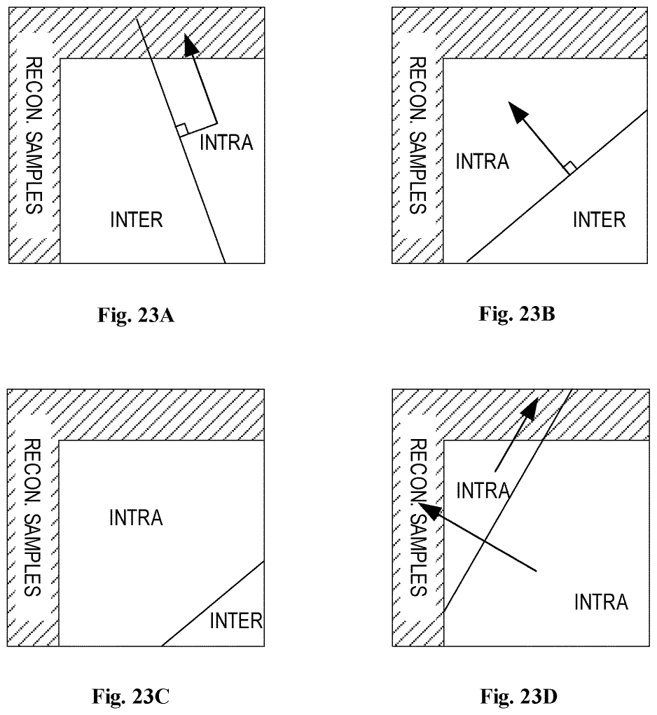

In GPM with inter and intra prediction, the final prediction samples are generated by weighting inter predicted samples and intra predicted samples for each GPM-separated region. The inter predicted samples are derived by inter GPM whereas the intra predicted samples are derived by an intra prediction mode (IPM) candidate list and an index signaled from the encoder. The IPM candidate list size is predefined as 3. The available IPM candidates are the parallel angular mode against the GPM block boundary (Parallel mode), the perpendicular angular mode against the GPM block boundary (Perpendicular mode), and the Planar mode as shown FIG. 23A to FIG. 23C, respectively. Furthermore, GPM with intra and intra prediction as shown FIG. 23D is restricted to reduce the signalling overhead for IPMs and avoid an increase in the size of the intra prediction circuit on the hardware decoder. In addition, a direct motion vector and IPM storage on the GPM-blending area is introduced to further improve the coding performance.

In DIMD and neighboring mode based IPM derivation Parallel mode is registered first. Therefore, max two IPM candidates derived from the decoder-side intra mode derivation (DIMD) method and/or the neighboring blocks can be registered if there is not the same IPM candidate in the list. As for the neighboring mode derivation, there are five positions for available neighboring blocks at most, but they are restricted by the angle of GPM block boundary as shown in Table 2, which are already used for GPM with template matching (GPM-TM).

TABLE 2
The position of available neighboring blocks for IPM candidate derivation based on the angle
of GPM block boundary. A and L denotes the above and left side of the prediction block.

| Angle of GPM | 0 | 2 | 3 | 4 | 5 | 8 | 11 | 12 | 13 | 14 |
|---|---|---|---|---|---|---|---|---|---|---|
| 1st partition | A | A | A | A | L + A | L + A | L + A | L + A | A | A |
| 2nd partition | L + A | L + A | L + A | L | L | L | L | L + A | L + A | L + A |
| Partition angle | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

GPM-intra can be combined with GPM with merge with motion vector difference (GPM-MMVD). TIMD is used for on IPM candidates of GPM-intra to further improve the coding performance. The Parallel mode can be registered first, then IPM candidates of TIMD, DIMD, and neighboring blocks.

### 2.6.7 Template Matching Based Reordering for GPM Split Modes

In template matching based reordering for GPM split modes, given the motion information of the current GPM block, the respective TM cost values of GPM split modes are computed. Then, all GPM split modes are reordered in ascending ordering based on the TM cost values. Instead of sending GPM split mode, an index using Golomb-Rice code to indicate where the exact GPM split mode located in the reordering list is signaled.

The reordering method for GPM split modes is a two-step process performed after the respective reference templates of the two GPM partitions in a coding unit are generated, as follows:
extending GPM partition edge into the reference templates of the two GPM partitions, resulting in 64 reference templates and computing the respective TM cost for each of the 64 reference templates;
reordering GPM split modes based on their TM cost values in ascending order and marking the best 32 split modes as available split modes.

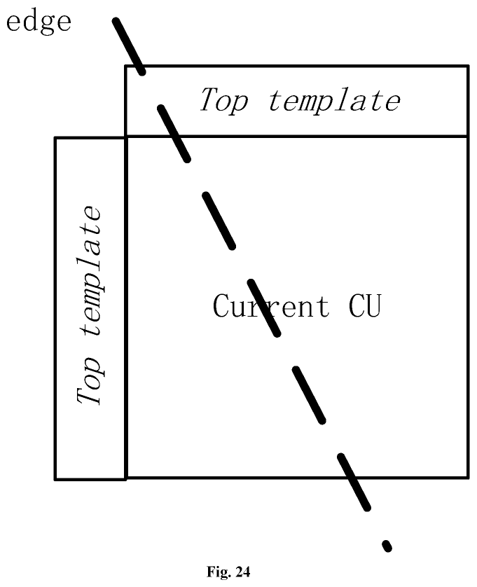

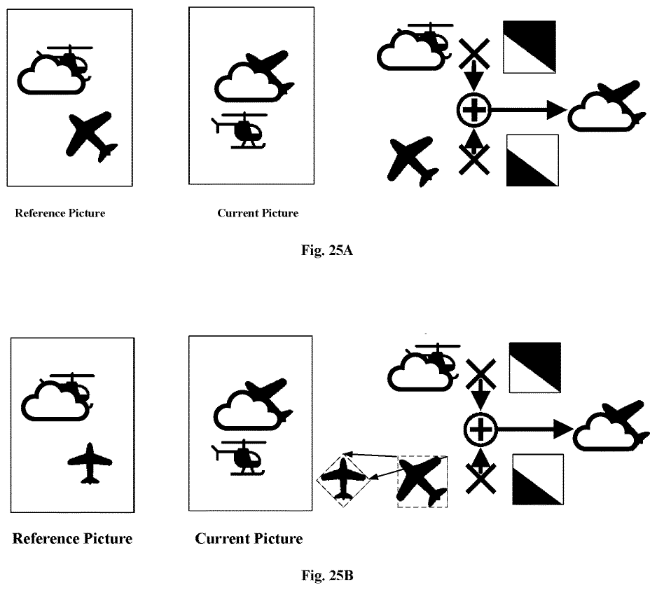

The edge on the template is extended from that of the current CU, as FIG. 24 illustrates, but GPM blending process is not used in the template area across the edge.

After ascending reordering using TM cost, an index is signaled.

### 2.6.8 Motion Field Storage for Geometric Partitioning Mode

Mv1 from the first part of the geometric partition, Mv2 from the second part of the geometric partition and a combined Mv of Mv1 and Mv2 are stored in the motion filed of a geometric partitioning mode coded CU.

The stored motion vector type for each individual position in the motion filed are determined as:

sType=abs(motionIdx)<32?2:(motionIdx≤0?(1−partIdx):partIdx) (2-43)

where motionIdx is equal to d(4x+2, 4y+2), which is recalculated from equation (2-36). The partIdx depends on the angle index i.

If sType is equal to 0 or 1, Mv0 or Mv1 are stored in the corresponding motion field, otherwise if sType is equal to 2, a combined My from Mv0 and Mv2 are stored. The combined My are generated using the following process:
1) If Mv1 and Mv2 are from different reference picture lists (one from L0 and the other from L1), then Mv1 and Mv2 are simply combined to form the bi-prediction motion vectors.
2) Otherwise, if Mv1 and Mv2 are from the same list, only uni-prediction motion Mv2 is stored.

### 2.7 Multi-Hypothesis Prediction (MHP)

In the multi-hypothesis inter prediction mode (JVET-M0425), one or more additional motion-compensated prediction signals are signaled, in addition to the conventional bi-prediction signal. The resulting overall prediction signal is obtained by sample-wise weighted superposition. With the bi-prediction signal p_{bi} and the first additional inter prediction signal/hypothesis h₃, the resulting prediction signal p₃ is obtained as follows:

p₃=(1−α)p_{bi}+αh₃.

The weighting factor α is specified by the new syntax element add_hyp_weight_idx, according to the following mapping.

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

pₙ₊₁=(1−αₙ₊₁)pₙ+αₙ₊₁hₙ₊₁

The resulting overall prediction signal is obtained as the last pₙ (i.e., the pₙ having the largest index n). Within this EE, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

### 2.8 Affine Motion Compensation in Geometry Prediction Mode

It is proposed that sub-block-based motion compensation may be used in the GPM mode.
a) In one example, the sub-block-based motion compensation may be affine motion compensation.
b) In one example, the sub-block-based motion compensation may be sbTMVP motion compensation.
c) In one example, the prediction of at least one geometry partition may be generated with sub-block-based motion compensation such as affine motion compensation.
d) In one example, the final prediction may be generated by a weighted sum of two predictions, where at least one of them is generated with sub-block-based motion compensation such as affine motion compensation.
   i. In one example, the weighted sum is performed with the weighting values defined by GPM.
e) In one example, the two predictions used in GPM mode may be type A and type B, wherein type A and type B may be (type A and type B may be the same type):
   i. Non-affine inter-prediction;
   ii. Affine inter-prediction;
   iii. Intra-prediction;
   iv. Intra block copy (IBC) prediction;
   v. sb-TMVP inter-prediction;
   vi. Any combined or generated prediction.

### ABBREVIATIONS

ACT adaptive colour transform
ALF adaptive loop filter
AMVR adaptive motion vector resolution
APS adaptation parameter set
AU access unit
AUD access unit delimiter
AVC advanced video coding (Rec. ITU-T H.264|ISO/IEC 14496-10)
B bi-predictive
BCW bi-prediction with CU-level weights
BDOF bi-directional optical flow
BDPCM block-based delta pulse code modulation
BP buffering period
CABAC context-based adaptive binary arithmetic coding
CB coding block
CBR constant bit rate
CCALF cross-component adaptive loop filter
CPB coded picture buffer
CRA clean random access
CRC cyclic redundancy check
CTB coding tree block
CTU coding tree unit
CU coding unit
CVS coded video sequence
DPB decoded picture buffer
DCI decoding capability information
DRAP dependent random access point
DU decoding unit
DUI decoding unit information
EG exponential-Golomb
EGk k-th order exponential-Golomb
EOB end of bitstream
EOS end of sequence
FD filler data
FIFO first-in, first-out
FL fixed-length
GBR green, blue, and red
GCI general constraints information
GDR gradual decoding refresh
GPM geometric partitioning mode
HEVC high efficiency video coding (Rec. ITU-T H.265 ISO/JEC 23008-2)
HRD hypothetical reference decoder
HSS hypothetical stream scheduler
I intra
IBC intra block copy
IDR instantaneous decoding refresh
ILRP inter-layer reference picture
IRAP intra random access point
LFNST low frequency non-separable transform
LIC Local Illumination Compensation
LPS least probable symbol
LSB least significant bit
LTRP long-term reference picture
LMCS luma mapping with chroma scaling
MIP matrix-based intra prediction
MPS most probable symbol
MSB most significant bit
MTS multiple transform selection
MVP motion vector prediction
NAL network abstraction layer
OBMC overlapped block motion compensation
OLS output layer set
OP operation point
OPI operating point information
P predictive
PH picture header
POC picture order count
PPS picture parameter set
PROF prediction refinement with optical flow
PT picture timing
PU picture unit
QP quantization parameter
RADL random access decodable leading (picture)
RASL random access skipped leading (picture)
RBSP raw byte sequence payload
RGB red, green, and blue
RPL reference picture list
SAO sample adaptive offset
SAR sample aspect ratio
SEI supplemental enhancement information
SH slice header
SLI subpicture level information
SODB string of data bits
SPS sequence parameter set
STRP short-term reference picture
STSA step-wise temporal sublayer access
TR truncated rice
VBR variable bit rate
VCL video coding layer
VPS video parameter set
VSEI versatile supplemental enhancement information (Rec. ITU-T H.274|ISO/IEC 23002-7)
VUI video usability information
VVC versatile video coding (Rec. ITU-T H.266|ISO/IEC 23090-3)

### 3. Problems to be Solved

In prior-arts, affine motion may also be used to generate predictions in GPM. But it is unclear how to harmonize affine in GPM with other coding tools.

### 4. Detailed Solutions

In the present disclosure, we propose to refine Affine CPMV with template matching. For a given Affine candidate in Affine candidate list, the CPMV may be further refined with template matching, and the refined Affine candidate is then used to derive sub-block or pixel level Affine motion information for the current block.

The detailed embodiments below should be considered as examples to explain general concepts. These embodiments should not be interpreted in a narrow way. Furthermore, these embodiments can be combined in any manner.

The terms ‘video unit’ or ‘coding unit’ or ‘block’ may represent a coding tree block (CTB), a coding tree unit (CTU), a coding block (CB), a CU, a PU, a TU, a PB, a TB.

The terms ‘Affine block’ may represent a block coded with Affine merge, Affine AMVP or any other Affine variant mode (i.e., Affine MMVD etc), which may be described by motion information of two control point (4-parameter) or three control point motion vectors (6-parameter). The terms ‘CPMV’ may represent the motion information of a Affine block at top-left, top-right and/or bottom-left corners.

The term ‘template’ may represent a reconstructed region that can be used to refine the CPMV, which may represent either ‘separate template’ or ‘unified template’. Here a ‘separate template’ may represent a reconstructed region that can be used to refine individual CPMV, i.e., specific one(s) of top-left, top-right and/or bottom-left corners, while a ‘unified template’ may represent a reconstructed region that can be used to refine all or arbitrary CPMV(s) for a block. The term ‘template matching cost’ or ‘TM cost’ may represent either matching cost of a separate template or a unified template.

In the present disclosure, regarding “a block coded with mode N”, here “mode N” may be a prediction mode (e.g., MODE_INTRA, MODE_INTER, MODE_PLT, MODE_IBC, and etc.), or a coding technique (e.g., DIMD, TIMD, PDPC, CCLM, CCCM, GLM, intraTMP, AMVP, SMVD, Merge, BDOF, PROF, DMVR, AMVR, TM, Affine, CIIP, GPM, spatial GPM, SGPM, GPM inter-inter, GPM intra-intra, GPM inter-intra, MHP, GEO, TPM, MMVD, BCW, HMVP, SbTMVP, LIC, OBMC, ALF, deblocking, SAO, bilateral filter, LMCS, and the corresponding variants, and etc.).

It is noted that the terminologies mentioned below are not limited to the specific ones defined in existing standards. Any variance of the coding tool is also applicable.
1. It is proposed that OBMC may be used on the affine motion compensation in GPM.
   a) In one example, OBMC may be applied on the fused prediction in GPM, which is generated by fusing (such as weighted averaging) two predictions of the two GPM partitions.
      i. In one example, OBMC is not applied on a prediction of a GPM partition before the fusion.
      ii. In one example, at least one of the two predictions may be generated with affine motion compensation.
      iii. In one example, OBMC may be applied on the fused prediction with the motion information stored to the block by GPM.
      iv. In one example, OBMC may be applied on the fused prediction in a first way for affine prediction.
      v. In one example, OBMC may be applied on the fused prediction in a second way for non-affine prediction.
      vi. In one example, whether OBMC is applied on the fused prediction in a first way or the second way may depend on whether a GPM partition is affine coded and/or how to split the block in GPM mode.
   b) In one example, OBMC may be applied on a prediction of a GPM partition before the fusion.
      i. In one example, OBMC is not applied on the fused prediction in GPM.
      ii. In one example, at least one of the two predictions may be generated with affine motion compensation.
      iii. In one example, OBMC may be applied on the prediction of a GPM partition with the motion information used for the GPM partition.
      iv. In one example, OBMC may be applied on the prediction before fusion in a first way for affine prediction.
      v. In one example, OBMC may be applied on the prediction before fusion in a second way for non-affine prediction.
      vi. In one example, whether OBMC is applied on the prediction before fusion in a first way or the second way may depend on whether the GPM partition is affine coded.
   c) Whether to apply OBMC on a GPM block before or after the fusion process may depend on coding mode of at least one GPM partition.
      i. In one example, OBMC may be applied on a GPM block before the fusion process if a GPM partition is coded with intra-prediction.
      ii. In one example, OBMC may be applied on a GPM block before the fusion process if a GPM partition is coded with affine prediction.
      iii. In one example, OBMC may be applied on a GPM block before the fusion process if a GPM partition is coded with GPM-MMVD mode.
      iv. In one example, OBMC may be applied on a GPM block before the fusion process if a GPM partition is coded with GPM-TM mode.
      v. In one example, OBMC may be applied on a GPM block before the fusion process if a GPM partition is coded with uni-prediction.
      vi. In one example, OBMC may be applied on a GPM block before the fusion process if a GPM partition is coded with bi-prediction.
      vii. In one example, OBMC may be applied on a GPM block after the fusion process if a GPM partition is coded with intra-prediction.
      viii. In one example, OBMC may be applied on a GPM block after the fusion process if a GPM partition is coded with affine prediction.
      ix. In one example, OBMC may be applied on a GPM block after the fusion process if a GPM partition is coded with GPM-MMVD mode.
      x. In one example, OBMC may be applied on a GPM block after the fusion process if a GPM partition is coded with GPM-TM mode.
      xi. In one example, OBMC may be applied on a GPM block after the fusion process if a GPM partition is coded with uni-prediction.
      xii. In one example, OBMC may be applied on a GPM block after the fusion process if a GPM partition is coded with bi-prediction.
   d) In one example, whether to and/or how to apply OBMC in GPM may depend on coding information such as block width/height, QP, coding modes, etc.
2. It is proposed that ARMC may be applied to modify a candidate list used in GPM.
   a) In one example, a candidate list used in GPM may be reordered before being used in GPM.
      i. In one example, after reordering the list, a first candidate may be put before a second candidate in the list if the cost of the first candidate is smaller (or no greater) than the cost of the second candidate.
         1) In one example, the cost of a candidate may be calculated as a distortion (such as SAD) between a template of the current block and a reference template derived by the motion information and/or the intra-prediction mode of the candidate.
      ii. In one example, a first merge candidate list may be reordered when it is used in GPM.
      iii. In one example, a second candidate list which is derived from the first merge candidate list for GPM may be reordered.
         1) In one example, the second candidate list may consists uni-prediction candidate(s) only.
      iv. In one example, an affine merge candidate list may be reordered when it is used in GPM.
         1) In one example, the reference template of an affine merge candidate may consist multiple sub-templates which are located with motion information derived with the affine model.
         a) In one example, the motion vector of a sub-template may be derived for a position in the sub-template (such as the center position) with the affine model.
         b) In one example, the motion vector of a sub-template may be set equal to a motion vector of a subblock of the current block next to the sub-template.
         2) In one example, a first affine merge candidate list which may comprise bi-prediction may be reordered when it is used in GPM.
         3) In one example, a second affine merge candidate list which only comprises uni-prediction may be reordered when it is used in GPM.
         a) The second affine merge candidate list may be derived from the first affine merge candidate list.
      v. In one example, when ARMC is applied in GPM, candidates in a list may be divided into multiple groups. Candidates are compared and reordered only in the same group. The order of different groups may be fixed.
   b) In one example, GPM-MMVD candidates may be reordered.
   c) In one example, whether to and/or how to do the modification (such as reordering) may depend on coding information such as block width/height, QP, coding modes, etc.
      i. For example, a first kind of candidate list in GPM is reordered, but a second kind of candidate list in GPM is not reordered.
         1) E.g. the first kind of candidate list is an affine merge candidate list and the second kind of candidate list is a non-affine merge candidate list.
   d) Suppose a second candidate list may be derived from a first candidate list in the GPM mode. For example, the second candidate list may be constructed from the first candidate list by generating uni-prediction candidates.
      i. The first candidate list may be reordered and the reordered candidate list may be constructed based on the reordered first candidate list.
      ii. The first candidate list may not be reordered and the reordered candidate list may be constructed based on the first candidate list without reordering.
      iii. The second candidate list may be reordered after being constructed.
   e) In one example, the number of candidates involved in the reordering process may be different from the number of candidates used in GPM.
      i. In one example, S candidates may be reordered, and the first P candidates after reordering may be used in GPM, where S>=P.
         1) For example, a second candidate list with S candidates may be derived from a first candidate list in the GPM mode. After reordering, the first P candidates in the second candidate list may be used by GPM.
         2) In one example, S and/or P may be signalled to the decoders, such as in VPS/SPS/PPS/picture header/slice header/CTU row/CTU/CU/etc.
         3) In one example, S may depend on P.
         4) In one example, P may depend on S.
         5) In one example, S and/or P may depend on coding information such as picture or block width/height, QP, temporal layers, CTU size, etc.
   f) In one example, whether to and/or how to reorder candidates used in GPM may depend on whether GPM-affine is applied.
      i. In one example, all methods disclosed about candidates reordering may be applied to GPM-affine.
   g) In one example, whether to and/or how to reorder candidates for GPM may depend on the GPM split mode.
      1) For example, the selection of samples of the template may depend on the GPM split mode.
3. In one example, whether to and/or how to apply template matching based reordering for GPM split modes may depend on coding information such as block width/height, QP, coding modes, etc.
   a) In one example, whether to and/or how to reorder GPM split modes may depend on whether a GPM partition is coded with affine motion compensation.
      1) For example, a reference template used to reorder GPM split modes may be generated in a way derived by the affine model. For example, it may consist multiple sub-templates which are located with motion information derived with the affine model.
         a) In one example, the motion vector of a sub-template may be derived for a position in the sub-template (such as the center position) with the affine model.
         b) In one example, the motion vector of a sub-template may be set equal to a motion vector of a subblock of the current block next to the sub-template.
   b) In one example, whether to generate a reference template used to reorder GPM split modes in a way derived by the affine model or not may depend on whether a corresponding GPM partition is coded with affine motion compensation.
      i. For example, a reference template used to reorder GPM split modes may be generated in a way derived by the affine model if the corresponding GPM partition is coded with affine motion compensation.
      ii. For example, a reference template used to reorder GPM split modes may not be generated in a way derived by the affine model if the corresponding GPM partition is not coded with affine motion compensation.
4. In one example, whether the motion information of a partition in GPM can be modified may depend on whether the partition is coded with affine motion compensation or not.
   a) In one example, the motion information of a partition in GPM may be modified by MMVD.
   b) In one example, the motion information of a partition in GPM can be modified by TM.
   c) In one example, the motion information of a partition in GPM cannot be modified by MMVD if it is coded with affine motion compensation.
      i. Alternatively, a partition in GPM cannot be coded with affine motion compensation if the motion information is modified by MMVD.
   d) In one example, the motion information of a partition in GPM cannot be modified by TM if it is coded with affine motion compensation.
      i. Alternatively, a partition in GPM cannot be coded with affine motion compensation if the motion information is modified by TM.
5. In one example, different candidate lists may be applied in different cases in GPM.
   a) In one example, which candidate list is used for a GPM partition may depend on whether MMVD GPM is applied for the GPM partition.
      i. For example, a first candidate list may be used for the GPM partition if MMVD GPM is not applied in the GPM partition, wherein the first candidate list may comprise a bi-prediction candidate. E.g., the first candidate list may be the same as the regular merge candidate list.
      ii. For example, a second candidate list may be used for the GPM partition if MMVD GPM is applied in the GPM partition, wherein the second candidate list cannot comprise a bi-prediction candidate.
         1) The second candidate list may be derived from the first candidate list.
         a) E.g. Candidate K in the second candidate list may be copied from Candidate K in the first candidate list if it is a uni-prediction candidate.
         b) E.g. Candidate K in the second candidate list may be set to be the motions referring to reference list 0 of Candidate K in the first candidate list if it is a bi-prediction candidate.
         c) E.g. Candidate K in the second candidate list may be set to be the motions referring to reference list 1 of Candidate K in the first candidate list if it is a bi-prediction candidate.
         d) E.g. Whether Candidate K in the second candidate list is set to be the motions referring to reference list 0 or reference list 1 of Candidate K in the first candidate list may depend on the parity of K.
         i. E.g. Candidate K in the second candidate list may be set to be the motions referring to reference list [K&1] of Candidate K in the first candidate list if it is a bi-prediction candidate.
         ii. E.g. Candidate K in the second candidate list may be set to be the motions referring to reference list [(K+1)&1] of Candidate K in the first candidate list if it is a bi-prediction candidate.
   iii. In one example, the candidate lists may be affine or non-affine candidate lists.
6. In one example, whether GPM is applicable in a specific condition may depend on whether GPM with affine motion compensation is applicable.
   a) In one example, suppose the width and height of the current block are denoted as W and H respectively, then the following rule may be applied:
      i. GPM is applicable only if TW0<=W<=TW1 and TH0<=H<=TH1, if GPM with affine motion compensation is not applicable. For example, TW0=TH0=8 and TW1=TH1=64.
      ii. GPM is applicable only if TW0′<=W<=TW1‘ and TH0’<=H<=TH1′, if GPM with affine motion compensation is applicable, and
         1) TW0′ may not be equal to TW0;
         2) TW1′ may not be equal to TW1;
         3) TH0′ may not be equal to TH0;
         4) TH1′ may not be equal to TH1;
         5) For example, TW0′=TH0′=16 and TW1′=TH1′=128.
   b) If GPM is applicable in a specific condition only if GPM with affine motion compensation is applicable (such as W or H is equal to 128), then it may be implicitly determined that GPM with affine motion compensation should be performed, without signalling.
   c) If GPM is applicable in a specific condition only if GPM with affine motion compensation is not applicable (such as W or H is equal to 8), then it may be implicitly determined that GPM without affine motion compensation should be performed, without signalling.
7. In one example, the number of applicable GPM split modes may depend on whether a GPM partition is coded with affine motion compensation.
   a) For example, signalling of the GPM split mode may depend on whether a GPM partition is coded with affine motion compensation.
   b) In one example, S GPM split modes may be applicable when at least one GPM partition is affine coded and P GPM split modes may be applicable when no GPM partition is affine coded, then S may be unequal to P.
      i. E.g. S>P.
      ii. E.g. S<P.
   c) In one example, S GPM split modes may be applicable when both GPM partitions are affine coded and P GPM split modes may be applicable when at least one GPM partition is non-affine coded, then S may be unequal to P.
      i. E.g. S>P.
      ii. E.g. S<P.
8. In one example, how to apply affine or other subblock based prediction may depend on whether it is used in GPM.
   a) In one example, the subblock size may be different when affine or other subblock based prediction is applied in GPM or not.
      i. For example, the subblock size may be 2×2 if affine or other subblock based prediction is applied in GPM.
      ii. For example, the subblock size may be 1×1 (pixel level) if affine or other subblock based prediction is applied in GPM.

### General Aspects

9. Additional operations may be applied to or with the proposed method.
   a) A syntax element disclosed above may be binarized as a flag, a fixed length code, an EG(x) code, a unary code, a truncated unary code, a truncated binary code, etc. It can be signed or unsigned.
   b) A syntax element representing a coding tool or a coding method may not be signalled and implicitly determined to be unused, if the coding tool or the coding method is regarded as not applicable or cannot be used.
   c) A syntax element disclosed above may be coded with at least one context model. Or it may be bypass coded.
   d) A syntax element disclosed above may be signaled in a conditional way.
      a. The SE is signaled only if the corresponding function is applicable.
      b. The SE is signaled only if the dimensions (width and/or height) of the block satisfy a condition.
   e) A syntax element disclosed above may be signaled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
   f) Whether to and/or how to apply the disclosed methods above may be signalled at block level/sequence level/group of pictures level/picture level/slice level/tile group level, such as in coding structures of CTU/CU/TU/PU/CTB/CB/TB/PB, or sequence header/picture header/SPS/VPS/DPS/DCI/PPS/APS/slice header/tile group header.
   g) Whether to and/or how to apply the disclosed methods above may be dependent on coded information, such as block size, colour format, single/dual tree partitioning, colour component, slice/picture type.
   h) The proposed methods disclosed in this document may be used in other coding tools which require chroma fusion.
      Geometric Partitioning Mode with Affine
      Overlapping Objects with Different Motions

GPM is a sophisticated coding tool to deal with two overlapping objects moving independently. As shown in FIG. 25A, MC can be performed targeting at two objects to obtain two predictions. And the GPM prediction, which is a fusion of the two objects, is derived as the weighted sum of the two predictions.

Although GPM has been extended in several ways in ECM, it can only deal with TMC. In many scenarios, at least one of the two overlapping objects may move in a non-translational way. The left part of FIG. 25B shows an example, where the cloud and a helicopter move along a translational trajectory while the plane's motion follows an affine model. It is obvious that GPM in VVC or ECM cannot directly handle overlapping objects with affine motions. Intuitively, if the prediction for the plane can be conducted following the affine model, we still can generate a high-quality GPM prediction, as shown in the right part of FIG. 25B.

### GPM-Affine

Following the idea depicted in FIG. 25B, GPM-affine is proposed to harmonize GPM and affine motion compensation (AMC) targeting at overlapping objects with affine motions. Specifically, GPM is extended to enable AMC. Therefore, a GPM partition can be predicted by AMC inter-prediction, translational motion compensation (TMC) inter-prediction or intra-prediction. As a flexible design, a GPM partition predicted by AMC can be combined with the other GPM partition predicted by AMC, TMC, or intra-prediction.

A gpm_affine_flag is signaled for each GPM partition to indicate whether AMC is applied for the GPM partition. In the current implementation, AMC is not allowed for GPM-MMVD and GPM-TM. Specifically, gpm_affine_flag for a GPM partition is not signaled and inferred to be false if GPM-MMVD is applied for the GPM partition. Besides, if gpm_affine_flag is true for at least one GPM partition, GPM-TM flag is not signaled and inferred to be false. A merge candidate index for the GPM partition is signaled no matter gpm_affine_flag is true or false. But since the candidate index may have different meanings, either referring to a TMC merge candidate or to an AMC merge candidate, so different arithmetic context models are used to code the candidate index, depending on whether gpm_affine_flag is true or false.

When at least one gpm_affine_flag is true, a uni-prediction affine merge candidate list is constructed from the subblock-based merge candidate list without sub-TMVP candidates before being reordered by ARMC. A candidate in the uni-prediction affine merge candidate list is generated by fetching CPMVs of a candidate in the subblock-based merge candidate list referring to only one reference list, depending on the parity of the index, similar to the uni-prediction merge candidate list construction for GPM in VVC. After the construction, ARMC is applied to reorder the candidates in the uni-prediction affine merge candidate list according to the template cost of each candidate in the list. It should be noted that a pruning operation is conducted to avoid any duplicated candidate in the uni-prediction affine merge candidate list. In our implementation, the size of the uni-prediction affine merge candidate list is set to be 15, which is the same as that of the TMC merge candidate list used by GPM.

When AMC is indicated to be used for a GPM partition, CPMVs of a candidate are retrieved from the uni-prediction affine merge candidate list according to the merge candidate index signaled for the GPM partition. AMC is then applied to the whole CU with the retrieved CPMVs to get the AMC prediction. The final GPM prediction is still generated as a weighted sum of two predictions, one of which is the AMC prediction.

GPM splitting modes can still be reordered based on template costs if one or two GPM partitions apply AMC. The only change is that the reference template should be located according to the affine models instead of being located using a single MV.

After encoding or decoding a CU coded with GPM-affine, the affine models are stored to be used by succeeding blocks. On the one hand, CPMVs of a GPM partition coded with AMC are stored in 4×4 basic blocks which are covered by the GPM partition. The stored CPMVs can be used to generate inherited affine candidates for succeeding CUs. On the other hand, the affine parameters {a, b, c, d} used by GPM-affine are stored in the history table to generate HAMI affine candidates for the following CUs.

### Encoder Design

An efficient and fast encoding algorithm plays a key role in the success of GPM since there is a huge number of possible combinations of motions and splitting modes. A smart encoder design is even more challenging to GPM-affine because the possible motion candidates are doubled (15 for AMC and 15 for TMC). It is critical to find a sweet trade-off between the coding performance and the encoding speed. In general, we reuse the main encoding design for GPM in ECM, adding necessary modifications for GPM-affine. A simplified procedure, omitting GPM-MMVD and GPM-TM, is sketched in five steps:
1 Perform luma MC on the whole block for the 15 TMC candidates and the 15 AMC candidates without considering MMVD and store the 30 predictions. Perform intra prediction on the whole block for 3 intra-prediction modes and store them.
2 Calculate and store the partial luma absolute difference (SAD) cost for each triple {split mode (0~63), candidate (0~32), partition index (0~1)}, where candidates 0~14 are TMC candidates, 15~29 are AMC candidates, and 30~32 are intra ones. The partial SAD is calculated only on samples belonging to one GPM partition.
3 Conduct a first round of rough estimation to find at most 85 preliminary selected combinations of {split mode, candidate 0, candidate 1} with lower SAD costs. The SAD cost is roughly calculated as a sum of two partial SADs output in step #2. If the candidate index of partition K (0 or 1) of a selected combination is 0~14, partition K is TMC predicted; if the index is 15~29, partition K is AMC predicted; Otherwise, partition K is intra predicted.
4 Conduct a second round of rough estimation to further pick up at most 8 round-2 selected combinations out of the preliminary selected combinations in Step #3. The SAD cost is precisely calculated as the distortion between the original samples and the fused GPM prediction samples generated as a weighted sum.
5 Calculate Rate-Distortion Optimization (RDO) costs for the 8 round-2 selected combinations and find combination with the lowest cost as the final selection.

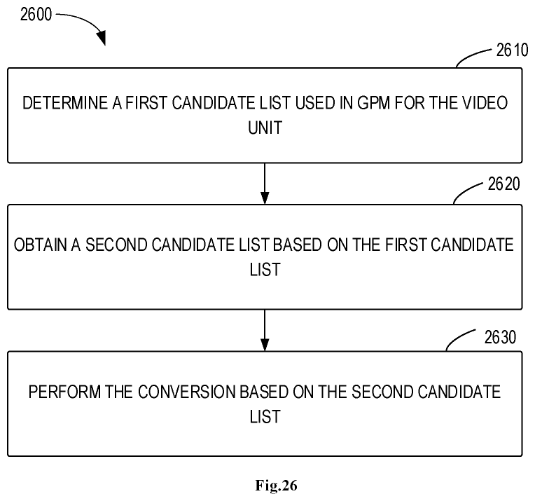

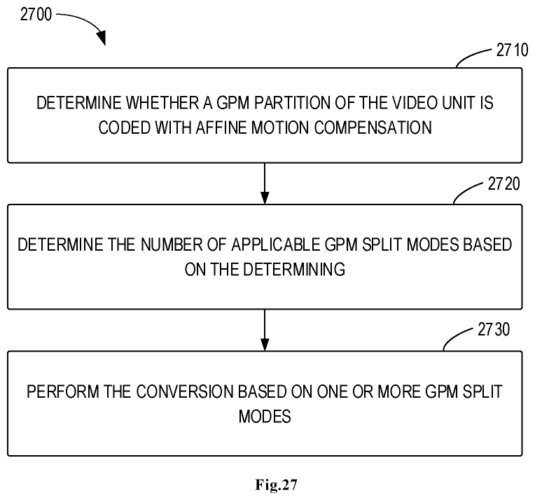

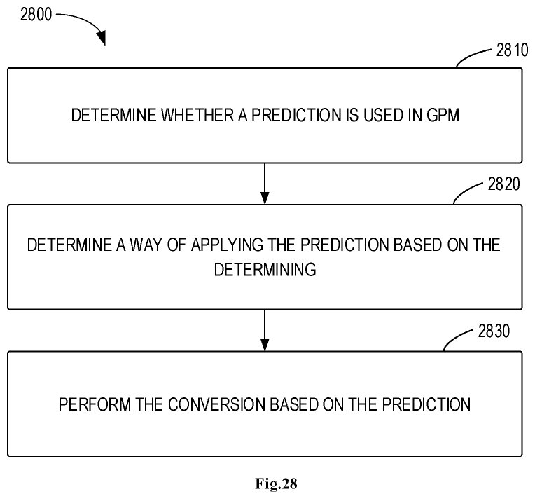

FIG. 26 illustrates a flowchart of a method 2600 for video processing in accordance with embodiments of the present disclosure. The method 2600 is implemented during a conversion between a video unit of a video and a bitstream of the video.

At block 2610, for a conversion between a video unit of a video and a bitstream of the video, a first candidate list used in a geometric partitioning mode (GPM) for the video unit is determined. The first candidate list may be a merge candidate list. The first candidate list may include bi-prediction candidates and/or uni-prediction candidates.

At block 2620, a second candidate list is obtained based on the first candidate list. A reordering process is applied to at least one of the first candidate list or the second candidate list. For example, if the reordering process is applied to the first candidate list, the second candidate list may be constructed from the reordered first candidate list. Alternatively, if the reordering process is not applied to the first candidate list, the second candidate list may be constructed from the first candidate list. In some other embodiments, the second candidate list may be reordered. Alternatively, the reordering process is not applied to the first and second candidate lists.

At block 2630, the conversion is performed based on the second candidate list. In some embodiments, the conversion includes encoding the video unit into the bitstream. In some embodiments, the conversion includes decoding the video unit from the bitstream. In this way, the affine in GPM is harmonized, thereby improving coding efficiency and performance.

In some embodiments, the second candidate list may only include uni-prediction candidates. For example, the second candidate list is constructed from the first candidate list by generating uni-prediction candidates.

In some embodiments, the first candidate list is reordered. In this case, second candidate list may be constructed based on the reordered first candidate list. In some other embodiments, the first candidate list is not reordered, and the second candidate list is constructed based on the first candidate list without reordering. In some further embodiments, the second candidate list is reordered after being constructed.

In some embodiments, the number of candidates involved in the reordering process is different from the number of candidates used in GPM. In some embodiments, S candidates are reordered, and first P candidates after reordering are used in GPM. In this case, S and P are integers and S is larger than or equal to P. For example, the second candidate list with S candidates is derived from the first candidate list in the GPM mode, and after reordering, first P candidates in the second candidate list are used by GPM.

In some embodiments, a value of S and/or a value of P are signalled to a decoder. In some other embodiments, the value of S and/or the value of P are signalled in one of: a video parameter set (VPS), a sequence parameter set (SPS), a picture parameter set (PPS), a picture header, a slice header, a coding tree unit (CTU) row, a CTU, or a coding unit (CU).

In some embodiments, a value of S depends on a value of P. Alternatively the value of P depends on the value of S.

In some embodiments, a value of S and/or a value of P depends on coding information. For example, the coding information comprises at least one of: picture width, picture height, block width, block height, quantization parameter (QP), temporal layers, or CTU size.

In some embodiments, whether to and/or how to reorder candidates used in GPM depend on whether GPM-affine is applied. In some embodiments, an approach related to the reordering process is applied to GPM-affine. In one example, all methods disclosed about candidates reordering may be applied to GPM-affine.

In some embodiments, whether to and/or how to reorder candidates for GPM depend on a GPM split mode. In some embodiments, a selection of samples of a template depends on the GPM split mode.

In some embodiments, whether to and/or how to obtain the second candidate list is signalled at in one of the following: sequence level, group of pictures level, picture level, slice level, or tile group level. In some other embodiments, whether to and/or how to obtain the second candidate list is signalled at in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some further embodiments, whether to and/or how to obtain the second candidate list is signalled at in one of the following: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

In some embodiments, the method 2600 further comprises: determining, based on coded information of the video unit, whether to and/or how to obtain the second candidate list. The coded information may include at least one of: a block size, a colour format, a single and/or dual tree partitioning, a colour component, a slice type, or a picture type.

In some embodiments, a syntax element is binarized as one of the following: a flag, a fixed length code, an EG(x) code, a unary code, a truncated unary code, or a truncated binary code. In some embodiments, the syntax element is signed or unsigned.

In some embodiments, a syntax element is coded with at least on context model, or wherein a syntax element is bypass coded. In some embodiments, the syntax element is signaled in a conditional way.

In some embodiments, the syntax element is signaled, if a corresponding function is applicable. Alternatively, the syntax element is signaled, if dimensions of the video unit satisfy a condition. In some embodiments, the dimensions include width and/or height of the video unit.

In some embodiments, the syntax element is signaled at one of: sequence level, group of pictures level, picture level, slice level, or tile group level. In some embodiments, the syntax element is signaled at one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the syntax element is signaled at one of: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel. In some embodiments, the video unit is coded with one or more other coding tools that require chroma fusion.

According to further embodiments of the present disclosure, a non-transitory computer-readable recording medium is provided. The non-transitory computer-readable recording medium stores a bitstream of a video which is generated by a method performed by an apparatus for video processing. The method comprises: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; and generating the bitstream based on the second candidate list.

According to still further embodiments of the present disclosure, a method for storing bitstream of a video is provided. The method comprises: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; generating the bitstream based on the second candidate list; and storing the bitstream in a non-transitory computer-readable recording medium.

FIG. 27 illustrates a flowchart of a method 2700 for video processing in accordance with embodiments of the present disclosure. The method 2700 is implemented during a conversion between a video unit of a video and a bitstream of the video.

At block 2710, for a conversion between a video unit of a video and a bitstream of the video, whether a geometric partitioning mode (GPM) partition of the video unit is coded with affine motion compensation is determined.

At block 2720, the number of applicable GPM split modes is determined based on the determining.

At block 2730, the conversion is performed based on one or more GPM split modes. In some embodiments, the conversion includes encoding the video unit into the bitstream. In some embodiments, the conversion includes decoding the video unit from the bitstream. In this way, the affine in GPM is harmonized, thereby improving coding efficiency and performance.

In some embodiments, a signalling of the one or more GPM split modes depends on whether the GPM partition is coded with affine motion compensation. In some embodiments, S GPM split modes are applicable, if at least one GPM partition is affine coded. In addition, P GPM split modes are applicable, if no GPM partition is affine coded. In this case, P are integers and S is unequal to P. In some embodiments, S is larger than P. Alternatively, S is smaller than P.

In some embodiments, S GPM split modes are applicable, if both GPM partitions are affine coded. In addition, P GPM split modes are applicable, if at least one GPM partition is non-affine coded. In this case, S is unequal to P. In some embodiments, S is larger than P. Alternatively, S is smaller than P.

In some embodiments, whether to and/or how to determine the number of applicable GPM split modes is signalled at in one of the following: sequence level, group of pictures level, picture level, slice level, or tile group level. In some other embodiments, whether to and/or how to determine the number of applicable GPM split modes is signalled at in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some further embodiments, whether to and/or how to determine the number of applicable GPM split modes is signalled at in one of the following: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

In some embodiments, the method 2700 further comprises: determining, based on coded information of the video unit, whether to and/or how to determine the number of applicable GPM split modes. The coded information may include at least one of: a block size, a colour format, a single and/or dual tree partitioning, a colour component, a slice type, or a picture type.

In some embodiments, a syntax element is binarized as one of the following: a flag, a fixed length code, an EG(x) code, a unary code, a truncated unary code, or a truncated binary code. In some embodiments, the syntax element is signed or unsigned.

In some embodiments, a syntax element is coded with at least on context model, or wherein a syntax element is bypass coded. In some embodiments, the syntax element is signaled in a conditional way.

In some embodiments, the syntax element is signaled, if a corresponding function is applicable. Alternatively, the syntax element is signaled, if dimensions of the video unit satisfy a condition. In some embodiments, the dimensions include width and/or height of the video unit.

In some embodiments, the syntax element is signaled at one of: sequence level, group of pictures level, picture level, slice level, or tile group level. In some embodiments, the syntax element is signaled at one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the syntax element is signaled at one of: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel. In some embodiments, the video unit is coded with one or more other coding tools that require chroma fusion.

According to further embodiments of the present disclosure, a non-transitory computer-readable recording medium is provided. The non-transitory computer-readable recording medium stores a bitstream of a video which is generated by a method performed by an apparatus for video processing. The method comprises: determining, for a conversion between a video unit of a video and a bitstream of the video, whether a geometric partitioning mode (GPM) partition of the video unit is coded with affine motion compensation; determining the number of applicable GPM split modes based on the determining; and generating the bitstream based on one or more GPM split modes.

According to still further embodiments of the present disclosure, a method for storing bitstream of a video is provided. The method comprises: determining, for a conversion between a video unit of a video and a bitstream of the video, whether a geometric partitioning mode (GPM) partition of the video unit is coded with affine motion compensation; determining the number of applicable GPM split modes based on the determining; generating the bitstream based on one or more GPM split modes; and storing the bitstream in a non-transitory computer-readable recording medium.

FIG. 28 illustrates a flowchart of a method 2800 for video processing in accordance with embodiments of the present disclosure. The method 2800 is implemented during a conversion between a video unit of a video and a bitstream of the video.

At block 2810, for a conversion between a video unit of a video and a bitstream of the video, whether a prediction is used in a geometric partitioning mode (GPM) is determined. The prediction is an affine based prediction or subblock based prediction.

At block 2820, a way of applying the prediction is determined based on the determining.

At block 2830, the conversion is performed based on the prediction. In some embodiments, the conversion includes encoding the video unit into the bitstream. In some embodiments, the conversion includes decoding the video unit from the bitstream. In this way, the affine in GPM is harmonized, thereby improving coding efficiency and performance.

In some embodiments, a subblock size is dependent on whether the prediction is applied in GPM or not. For example, the subblock size may be different when affine or other subblock based prediction is applied in GPM or not.

In some embodiments, the subblock size is 2×2, if the prediction is applied in GPM. In some other embodiments, the subblock size is 1×1, if the prediction is applied in GPM. The subblock size may be at pixel level.

In some embodiments, whether to and/or how to determine the way of applying the prediction is signalled at in one of the following: sequence level, group of pictures level, picture level, slice level, or tile group level. In some other embodiments, whether to and/or how to determine the way of applying the prediction is signalled at in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. In some further embodiments, whether to and/or how to determine the way of applying the prediction is signalled at in one of the following: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

In some embodiments, the method 2800 further comprises: determining, based on coded information of the video unit, whether to and/or how to determine the way of applying the prediction. The coded information may include at least one of: a block size, a colour format, a single and/or dual tree partitioning, a colour component, a slice type, or a picture type.

In some embodiments, a syntax element is binarized as one of the following: a flag, a fixed length code, an EG(x) code, a unary code, a truncated unary code, or a truncated binary code. In some embodiments, the syntax element is signed or unsigned.

In some embodiments, a syntax element is coded with at least on context model, or wherein a syntax element is bypass coded. In some embodiments, the syntax element is signaled in a conditional way.

In some embodiments, the syntax element is signaled, if a corresponding function is applicable. Alternatively, the syntax element is signaled, if dimensions of the video unit satisfy a condition. In some embodiments, the dimensions include width and/or height of the video unit.

In some embodiments, the syntax element is signaled at one of: sequence level, group of pictures level, picture level, slice level, or tile group level. In some embodiments, the syntax element is signaled at one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, the syntax element is signaled at one of: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel. In some embodiments, the video unit is coded with one or more other coding tools that require chroma fusion.

According to further embodiments of the present disclosure, a non-transitory computer-readable recording medium is provided. The non-transitory computer-readable recording medium stores a bitstream of a video which is generated by a method performed by an apparatus for video processing. The method comprises: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; and generating the bitstream based on the prediction.

According to still further embodiments of the present disclosure, a method for storing bitstream of a video is provided. The method comprises: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; generating the bitstream based on the prediction; and storing the bitstream in a non-transitory computer-readable recording medium.

Implementations of the present disclosure can be described in view of the following clauses, the features of which can be combined in any reasonable manner.

Clause 1. A method of video processing, comprising: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; and performing the conversion based on the second candidate list.

Clause 2. The method of clause 1, wherein the second candidate list is constructed from the first candidate list by generating uni-prediction candidates.

Clause 3. The method of clause 1, wherein the first candidate list is reordered, and the second candidate list is constructed based on the reordered first candidate list.

Clause 4. The method of clause 1, wherein the first candidate list is not reordered, and the second candidate list is constructed based on the first candidate list without reordering.

Clause 5. The method of clause 1, wherein the second candidate list is reordered after being constructed.

Clause 6. The method of clause 1, wherein the number of candidates involved in the reordering process is different from the number of candidates used in GPM.

Clause 7. The method of clause 6, wherein S candidates are reordered, and first P candidates after reordering are used in GPM, wherein S and P are integers and S is larger than or equal to P.

Clause 8. The method of clause 7, wherein the second candidate list with S candidates is derived from the first candidate list in the GPM mode, and after reordering, first P candidates in the second candidate list are used by GPM.

Clause 9. The method of clause 7, wherein a value of S and/or a value of P are signalled to a decoder.

Clause 10. The method of clause 9, wherein the value of S and/or the value of P are signalled in one of: a video parameter set (VPS), a sequence parameter set (SPS), a picture parameter set (PPS), a picture header, a slice header, a coding tree unit (CTU) row, a CTU, or a coding unit (CU).

Clause 11. The method of clause 7, wherein a value of S depends on a value of P, or wherein the value of P depends on the value of S.

Clause 12. The method of clause 7, wherein a value of S and/or a value of P depends on coding information.

Clause 13. The method of clause 12, wherein the coding information comprises at least one of: picture width, picture height, block width, block height, quantization parameter (QP), temporal layers, or CTU size.

Clause 14. The method of clause 1, wherein whether to and/or how to reorder candidates used in GPM depend on whether GPM-affine is applied.

Clause 15. The method of any of clauses 1-14, wherein an approach related to the reordering process is applied to GPM-affine.

Clause 16. The method of clause 1, wherein whether to and/or how to reorder candidates for GPM depend on a GPM split mode.

Clause 17. The method of clause 16, wherein a selection of samples of a template depends on the GPM split mode.

Clause 18. The method of any of clauses 1-17, wherein whether to and/or how to obtain the second candidate list is signalled at in one of the following: sequence level, group of pictures level, picture level, slice level, or tile group level.

Clause 19. The method of any of clauses 1-17, wherein whether to and/or how to obtain the second candidate list is signalled at in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 20. The method of any of clauses 1-17, wherein whether to and/or how to obtain the second candidate list is signalled at in one of the following: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

Clause 21. The method of any of clauses 1-17, further comprising: determining, based on coded information of the video unit, whether to and/or how to obtain the second candidate list, the coded information including at least one of: a block size, a colour format, a single and/or dual tree partitioning, a colour component, a slice type, or a picture type.

Clause 22. A method of video processing, comprising: determining, for a conversion between a video unit of a video and a bitstream of the video, whether a geometric partitioning mode (GPM) partition of the video unit is coded with affine motion compensation; determining the number of applicable GPM split modes based on the determining; and performing the conversion based on one or more GPM split modes.

Clause 23. The method of clause 22, wherein a signalling of the one or more GPM split modes depends on whether the GPM partition is coded with affine motion compensation.

Clause 24. The method of clause 22, wherein S GPM split modes are applicable, if at least one GPM partition is affine coded, and P GPM split modes are applicable, if no GPM partition is affine coded, and wherein S and P are integers and S is unequal to P.

Clause 25. The method of clause 24, wherein S is larger than P, or S is smaller than P.

Clause 26. The method of clause 22, wherein S GPM split modes are applicable, if both GPM partitions are affine coded, and P GPM split modes are applicable, if at least one GPM partition is non-affine coded, and wherein S is unequal to P.

Clause 27. The method of clause 26, wherein S is larger than P, or S is smaller than P.

Clause 28. The method of any of clauses 22-27, wherein whether to and/or how to determine the number of applicable GPM split modes is signalled at in one of the following: sequence level, group of pictures level, picture level, slice level, or tile group level.

Clause 29. The method of any of clauses 22-27, wherein whether to and/or how to determine the number of applicable GPM split modes is signalled at in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 30. The method of any of clauses 22-27, wherein whether to and/or how to determine the number of applicable GPM split modes is signalled at in one of the following: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

Clause 31. The method of any of clauses 22-27, further comprising: determining, based on coded information of the video unit, whether to and/or how to determine the number of applicable GPM split modes, the coded information including at least one of: a block size, a colour format, a single and/or dual tree partitioning, a colour component, a slice type, or a picture type.

Clause 32. A method of video processing, comprising: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; and performing the conversion based on the prediction.

Clause 33. The method of clause 32, wherein a subblock size is dependent on whether the prediction is applied in GPM or not.

Clause 34. The method of clause 33, wherein the subblock size is 2×2, if the prediction is applied in GPM.

Clause 35. The method of clause 33, wherein the subblock size is 1×1, if the prediction is applied in GPM.

Clause 36. The method of clause 34 or 35, wherein the subblock size is at pixel level.

Clause 37. The method of any of clauses 32-36, wherein whether to and/or how to determine the way of applying the prediction is signalled at in one of the following: sequence level, group of pictures level, picture level, slice level, or tile group level.

Clause 38. The method of any of clauses 32-36, wherein whether to and/or how to determine the way of applying the prediction is signalled at in one of the following: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 39. The method of any of clauses 32-36, wherein whether to and/or how to determine the way of applying the prediction is signalled at in one of the following: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

Clause 40. The method of any of clauses 32-36, further comprising: determining, based on coded information of the video unit, whether to and/or how to determine the way of applying the prediction, the coded information including at least one of: a block size, a colour format, a single and/or dual tree partitioning, a colour component, a slice type, or a picture type.

Clause 41. The method of any of clauses 1-40, wherein a syntax element is binarized as one of the following: a flag, a fixed length code, an EG(x) code, a unary code, a truncated unary code, or a truncated binary code.

Clause 42. The method of clause 41, wherein the syntax element is signed or unsigned.

Clause 43. The method of any of clauses 1-40, wherein a syntax element is coded with at least on context model, or wherein a syntax element is bypass coded.

Clause 44. The method of any of clauses 1-43, wherein the syntax element is signaled in a conditional way.

Clause 45. The method of clause 44, wherein the syntax element is signaled, if a corresponding function is applicable, or wherein the syntax element is signaled, if dimensions of the video unit satisfy a condition.

Clause 46. The method of clause 45, wherein the dimensions include width and/or height of the video unit.

Clause 47. The method of any of clauses 1-46, wherein the syntax element is signaled at one of: sequence level, group of pictures level, picture level, slice level, or tile group level.

Clause 48. The method of any of clauses 1-46, wherein the syntax element is signaled at one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 49. The method of any of clauses 1-46, wherein the syntax element is signaled at one of: a prediction block (PB), a transform block (TB), a coding block (CB), a prediction unit (PU), a transform unit (TU), a coding unit (CU), a coding tree block (CTB), a coding tree unit (CTU), a CTU row, a slice, a tile, a sub-picture, or a region including more than one sample or pixel.

Clause 50. The method of any of clauses 1-49, wherein the video unit is coded with one or more other coding tools that require chroma fusion.

Clause 51. The method of any of clauses 1-50, wherein the conversion includes encoding the video unit into the bitstream.

Clause 52. The method of any of clauses 1-50, wherein the conversion includes decoding the video unit from the bitstream.

Clause 53. An apparatus for video processing comprising a processor and a non-transitory memory with instructions thereon, wherein the instructions upon execution by the processor, cause the processor to perform a method in accordance with any of clauses 1-52.

Clause 54. A non-transitory computer-readable storage medium storing instructions that cause a processor to perform a method in accordance with any of clauses 1-52.

Clause 55. A non-transitory computer-readable recording medium storing a bitstream of a video which is generated by a method performed by an apparatus for video processing, wherein the method comprises: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; and generating the bitstream based on the second candidate list.

Clause 56. A method for storing a bitstream of a video, comprising: determining, for a conversion between a video unit of a video and a bitstream of the video, a first candidate list used in a geometric partitioning mode (GPM) for the video unit; obtaining a second candidate list based on the first candidate list, wherein a reordering process is applied to at least one of the first candidate list or the second candidate list, or the reordering process is not applied to the first and second candidate lists; generating the bitstream based on the second candidate list; and storing the bitstream in a non-transitory computer-readable recording medium.

Clause 57. A non-transitory computer-readable recording medium storing a bitstream of a video which is generated by a method performed by an apparatus for video processing, wherein the method comprises: determining, for a conversion between a video unit of a video and a bitstream of the video, whether a geometric partitioning mode (GPM) partition of the video unit is coded with affine motion compensation; determining the number of applicable GPM split modes based on the determining; and generating the bitstream based on one or more GPM split modes.

Clause 58. A method for storing a bitstream of a video, comprising: determining, for a conversion between a video unit of a video and a bitstream of the video, whether a geometric partitioning mode (GPM) partition of the video unit is coded with affine motion compensation; determining the number of applicable GPM split modes based on the determining; generating the bitstream based on one or more GPM split modes; and storing the bitstream in a non-transitory computer-readable recording medium.

Clause 59. A non-transitory computer-readable recording medium storing a bitstream of a video which is generated by a method performed by an apparatus for video processing, wherein the method comprises: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; and generating the bitstream based on the prediction.

Clause 60. A method for storing a bitstream of a video, comprising: determining, for a conversion between a video unit of a video and a bitstream of the video, whether a prediction is used in a geometric partitioning mode (GPM), wherein the prediction is an affine based prediction or subblock based prediction; determining a way of applying the prediction based on the determining; generating the bitstream based on the prediction; and storing the bitstream in a non-transitory computer-readable recording medium.

### Example Device

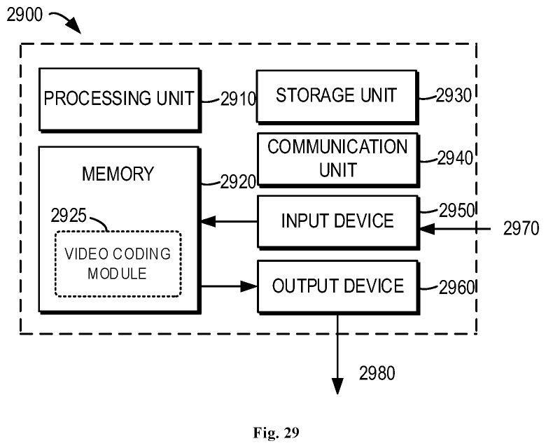

FIG. 29 illustrates a block diagram of a computing device 2900 in which various embodiments of the present disclosure can be implemented. The computing device 2900 may be implemented as or included in the source device 110 (or the video encoder 114 or 200) or the destination device 120 (or the video decoder 124 or 300).

It would be appreciated that the computing device 2900 shown in FIG. 29 is merely for purpose of illustration, without suggesting any limitation to the functions and scopes of the embodiments of the present disclosure in any manner.

As shown in FIG. 29, the computing device 2900 includes a general-purpose computing device 2900. The computing device 2900 may at least comprise one or more processors or processing units 2910, a memory 2920, a storage unit 2930, one or more communication units 2940, one or more input devices 2950, and one or more output devices 2960.

In some embodiments, the computing device 2900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2900 can support any type of interface to a user (such as “wearable” circuitry and the like).

The processing unit 2910 may be a physical or virtual processor and can implement various processes based on programs stored in the memory 2920. In a multi-processor system, multiple processing units execute computer executable instructions in parallel so as to improve the parallel processing capability of the computing device 2900. The processing unit 2910 may also be referred to as a central processing unit (CPU), a microprocessor, a controller or a microcontroller.

The computing device 2900 typically includes various computer storage medium. Such medium can be any medium accessible by the computing device 2900, including, but not limited to, volatile and non-volatile medium, or detachable and non-detachable medium. The memory 2920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2930 may be any detachable or non-detachable medium and may include a machine-readable medium such as a memory, flash memory drive, magnetic disk or another other media, which can be used for storing information and/or data and can be accessed in the computing device 2900.

The computing device 2900 may further include additional detachable/non-detachable, volatile/non-volatile memory medium. Although not shown in FIG. 29, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2940 communicates with a further computing device via the communication medium. In addition, the functions of the components in the computing device 2900 can be implemented by a single computing cluster or multiple computing machines that can communicate via communication connections. Therefore, the computing device 2900 can operate in a networked environment using a logical connection with one or more other servers, networked personal computers (PCs) or further general network nodes.

The input device 2950 may be one or more of a variety of input devices, such as a mouse, keyboard, tracking ball, voice-input device, and the like. The output device 2960 may be one or more of a variety of output devices, such as a display, loudspeaker, printer, and the like. By means of the communication unit 2940, the computing device 2900 can further communicate with one or more external devices (not shown) such as the storage devices and display device, with one or more devices enabling the user to interact with the computing device 2900, or any devices (such as a network card, a modem and the like) enabling the computing device 2900 to communicate with one or more other computing devices, if required. Such communication can be performed via input/output (I/O) interfaces (not shown).

In some embodiments, instead of being integrated in a single device, some or all components of the computing device 2900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2900 may be used to implement video encoding/decoding in embodiments of the present disclosure. The memory 2920 may include one or more video coding modules 2925 having one or more program instructions. These modules are accessible and executable by the processing unit 2910 to perform the functionalities of the various embodiments described herein.

In the example embodiments of performing video encoding, the input device 2950 may receive video data as an input 2970 to be encoded. The video data may be processed, for example, by the video coding module 2925, to generate an encoded bitstream. The encoded bitstream may be provided via the output device 2960 as an output 2980.

In the example embodiments of performing video decoding, the input device 2950 may receive an encoded bitstream as the input 2970. The encoded bitstream may be processed, for example, by the video coding module 2925, to generate decoded video data. The decoded video data may be provided via the output device 2960 as the output 2980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method of video processing, comprising:
determining, for a conversion between a video unit of a video and a bitstream of the video, a first candidate list used in a geometric partitioning mode (GPM) for the video unit;
obtaining a second candidate list based on the first candidate list, wherein a reordering process is applied to at least one of the first candidate list or the second candidate list, or the reordering process is not applied to the first and second candidate lists; and
performing the conversion based on the second candidate list.

2. The method of claim 1, wherein the second candidate list is constructed from the first candidate list by generating uni-prediction candidates, or
wherein the first candidate list is reordered, and the second candidate list is constructed based on the reordered first candidate list, or
wherein the first candidate list is not reordered, and the second candidate list is constructed based on the first candidate list without reordering, or
wherein the second candidate list is reordered after being constructed, or
wherein the number of candidates involved in the reordering process is different from the number of candidates used in GPM.

3. The method of claim 2, wherein S candidates are reordered, and first P candidates after reordering are used in GPM, wherein S and P are integers and S is larger than or equal to P.

4. The method of claim 3, wherein the second candidate list with S candidates is derived from the first candidate list in the GPM mode, and after reordering, first P candidates in the second candidate list are used by GPM, or
wherein a value of S and/or a value of P are signalled to a decoder, or
wherein a value of S depends on a value of P, or wherein the value of P depends on the value of S, or
wherein a value of S and/or a value of P depends on coding information.

5. The method of claim 4, wherein the value of S and/or the value of P are signalled in one of:
a video parameter set (VPS),
a sequence parameter set (SPS),
a picture parameter set (PPS),
a picture header,
a slice header,
a coding tree unit (CTU) row,
a CTU, or
a coding unit (CU).

6. The method of claim 4, wherein the coding information comprises at least one of:
picture width,
picture height,
block width,
block height,
quantization parameter (QP),
temporal layers, or
CTU size.

7. The method of claim 1, wherein whether to and/or how to reorder candidates used in GPM depend on whether GPM-affine is applied, or
wherein an approach related to the reordering process is applied to GPM-affine, or
wherein whether to and/or how to reorder candidates for GPM depend on a GPM split mode.

8. The method of claim 7, wherein a selection of samples of a template depends on the GPM split mode.

9. The method of claim 1, wherein whether a geometric partitioning mode (GPM) partition of the video unit is coded with affine motion compensation is determined, and the number of applicable GPM split modes is determined based on the determining.

10. The method of claim 9, wherein a signalling of the one or more GPM split modes depends on whether the GPM partition is coded with affine motion compensation, or
wherein S GPM split modes are applicable, if at least one GPM partition is affine coded, and
P GPM split modes are applicable, if no GPM partition is affine coded, and
wherein S and P are integers and S is unequal to P.

11. The method of claim 10, wherein S is larger than P, or S is smaller than P.

12. The method of claim 9, wherein S GPM split modes are applicable, if both GPM partitions are affine coded, and
P GPM split modes are applicable, if at least one GPM partition is non-affine coded, and
wherein S is unequal to P.

13. The method of claim 12, wherein S is larger than P, or S is smaller than P.

14. The method of claim 1, wherein whether a prediction is used in a geometric partitioning mode (GPM) is determined, wherein the prediction is an affine based prediction or subblock based prediction, and a way of applying the prediction is determined based on the determining.

15. The method of claim 14, wherein a subblock size is dependent on whether the prediction is applied in GPM or not.

16. The method of claim 15, wherein the subblock size is 2×2, if the prediction is applied in GPM, or
wherein the subblock size is 1×1, if the prediction is applied in GPM, or
wherein the subblock size is at pixel level.

17. The method of claim 1, wherein the conversion includes encoding the video unit into the bitstream, or
wherein the conversion includes decoding the video unit from the bitstream.

18. The method of claim 1, wherein the conversion comprises: generating the bitstream from the video, and
the method further comprises: storing the bitstream in a non-transitory computer-readable recording medium.

19. An apparatus for video processing comprising a processor and a non-transitory memory with instructions thereon, wherein the instructions upon execution by the processor, cause the processor to perform acts comprising:
determining, for a conversion between a video unit of a video and a bitstream of the video, a first candidate list used in a geometric partitioning mode (GPM) for the video unit;
obtaining a second candidate list based on the first candidate list, wherein a reordering process is applied to at least one of the first candidate list or the second candidate list, or the reordering process is not applied to the first and second candidate lists; and
performing the conversion based on the second candidate list.

20. A non-transitory computer-readable storage medium storing instructions that cause a processor to perform acts comprising:
determining, for a conversion between a video unit of a video and a bitstream of the video, a first candidate list used in a geometric partitioning mode (GPM) for the video unit;
obtaining a second candidate list based on the first candidate list, wherein a reordering process is applied to at least one of the first candidate list or the second candidate list, or the reordering process is not applied to the first and second candidate lists; and
performing the conversion based on the second candidate list.
